(19) United States
(12) Patent Application Publication
(10) Pub. No.: US 2016/0063765 A1
(43) Pub. Date: Mar. 3, 2016

(54) IMAGE PROCESSING APPARATUS AND IMAGE PROCESSING METHOD

(71) Applicants: Hiroyuki YOSHIDA, Tokyo (JP); Rieko ISHIHARA, Tokyo (JP); Yuki KAWATA, Tokyo (JP); Risa TSUTSUI, Tokyo (JP); Takuya OKAMOTO, Tokyo (JP); Ryonosuke MIYAZAKI, Tokyo (JP)

(72) Inventors: Hiroyuki YOSHIDA, Tokyo (JP); Rieko ISHIHARA, Tokyo (JP); Yuki KAWATA, Tokyo (JP); Risa TSUTSUI, Tokyo (JP); Takuya OKAMOTO, Tokyo (JP); Ryonosuke MIYAZAKI, Tokyo (JP)

(73) Assignee: RICOH COMPANY, LTD., Tokyo (JP)

(21) Appl. No.: 14/835,963

(22) Filed: Aug. 26, 2015

(30) Foreign Application Priority Data
Aug. 27, 2014 (JP) 2014-173048

(51) Int. Cl. G06T 19/00; H04N 13/04

(52) U.S. Cl. CPC G06T 19/006; H04N 13/0429; G06T 2219/2016

(57) ABSTRACT

An image processing apparatus includes: a first acquisition unit that acquires a document image; a first reception unit that receives specification of a display region of the document image on a screen of a display unit; an arrangement unit that calculates a virtual region corresponding to the specified display region in a virtual three-dimensional space; and a display control unit that performs control to display, on the display unit, a superimposition image formed by superimposing a background image and a two-dimensional document image obtained by projecting a three-dimensional document image formed by arranging the document image in the calculated virtual region onto a two-dimensional space visually recognized from a predetermined viewpoint position as a preview image estimating a print result of the document image.

### CROSS-REFERENCE TO RELATED APPLICATIONS

The present application claims priority to and incorporates by reference the entire contents of Japanese Patent Application No. 2014-173048 filed in Japan on Aug. 27, 2014.

### BACKGROUND OF THE INVENTION

1. Field of the Invention

The present invention relates to an image processing apparatus and an image processing method.

2. Description of the Related Art

An augmented reality (AR) technique in which information produced by a computer is superimposed on information provided from a real environment for display has been known. For example, Japanese Laid-open Patent Publication No. 2003-248843 discloses a technique in which an object arranged in a virtual three-dimensional space is displayed on a two-dimensional display and arrangement or the like of the object is performed on the two-dimensional display in accordance with an input by a user. To be specific, Japanese Laid-open Patent Publication No. 2003-248843 discloses a technique in which auxiliary lines along XYZ axes are displayed on a monitor and combinations of a mechanical signal indicating the input by the user and the auxiliary lines are interpreted so as to make editions.

The conventional techniques require the user to make an operation while being conscious of a structure of the object as an edition target in the virtual three-dimensional space and it is difficult to easily arrange the object in the virtual three-dimensional space.

### SUMMARY OF THE INVENTION

It is an object of the present invention to at least partially solve the problems in the conventional technology.

An image processing apparatus includes: a first acquisition unit that acquires a document image; a first reception unit that receives specification of a display region of the document image on a screen of a display unit; an arrangement unit that calculates a virtual region corresponding to the specified display region in a virtual three-dimensional space; and a display control unit that performs control to display, on the display unit, a superimposition image formed by superimposing a background image and a two-dimensional document image obtained by projecting a three-dimensional document image formed by arranging the document image in the calculated virtual region onto a two-dimensional space visually recognized from a predetermined viewpoint position as a preview image estimating a print result of the document image.

An image processing apparatus includes: a second acquisition unit that acquires a stereoscopic document image; a first reception unit that receives specification of a display region of one reference plane of the stereoscopic document image on a screen of a display unit; an arrangement unit that calculates a virtual region corresponding to the specified display region in a virtual three-dimensional space; and a display control unit that performs control to display, on the display unit, a superimposition image formed by superimposing a background image and a two-dimensional document image obtained by projecting a three-dimensional document image formed by arranging the stereoscopic document image such that the reference plane of the stereoscopic document image is identical to the calculated virtual region, onto a two-dimensional space visually recognized from a predetermined viewpoint position as a preview image estimating a print result of the stereoscopic document image.

An image processing method includes: acquiring a document image; receiving specification of a display region of the document image on a screen of a display unit; calculating a virtual region corresponding to the specified display region in a virtual three-dimensional space; and performing control to display, on the display unit, a superimposition image formed by superimposing a background image and a two-dimensional document image obtained by projecting a three-dimensional document image formed by arranging the document image in the calculated virtual region onto a two-dimensional space visually recognized from a predetermined viewpoint position as a preview image estimating a print result of the document image.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view schematically illustrating an image processing apparatus according to a first embodiment;

FIG. 2 is a block diagram illustrating the functional configuration of an image processing unit;

FIG. 3 is an explanatory diagram for explaining device coordinates and a display region that is specified;

FIG. 4 is a view illustrating an example of a data structure of display region information;

FIG. 5 is a view illustrating an example of a relation between four vertices of the display region and an image indicating the display region;

FIG. 6 is a view illustrating an example of a data structure of a light source information table;

FIG. 7 is a view illustrating an example of a data structure of a document reflection information table;

FIG. 8 is a functional block diagram of an arrangement unit;

FIG. 9 is an explanatory diagram for explaining a document plane temporarily arranged in a virtual three-dimensional space;

FIG. 10 is a view illustrating an example of initial arrangement coordinates of respective four vertices of the temporarily arranged document plane in the virtual three-dimensional space;

FIG. 11 is an explanatory diagrams for explaining calculation of projection matrices;

FIG. 12 is an explanatory diagram for explaining a relation between a conversion stage by open graphics library (OpenGL) and the projection matrices;

FIG. 13 is an explanatory diagram for explaining a relation among device coordinates, an inclination and position matrix, and the projection matrices;

FIG. 14 is a plan view schematically illustrating flow of a series of preview processing;

FIG. 15 is a view illustrating an example of a display screen;

FIG. 16 is an explanatory diagram for explaining movement, enlargement and reduction, and rotation;

FIG. 17 is an explanatory diagram for explaining flow of preview processing;

FIG. 18 is a block diagram illustrating the functional configuration of an image processing unit;

FIG. 19 is a plan view schematically illustrating flow of a series of preview processing; and

FIG. 20 is a diagram illustrating the hardware configuration of the image processing apparatus.

### DETAILED DESCRIPTION OF THE PREFERRED EMBODIMENTS

Hereinafter, embodiments of an image processing apparatus and an image processing method will be described in detail with reference to the accompanying drawings.

### First Embodiment

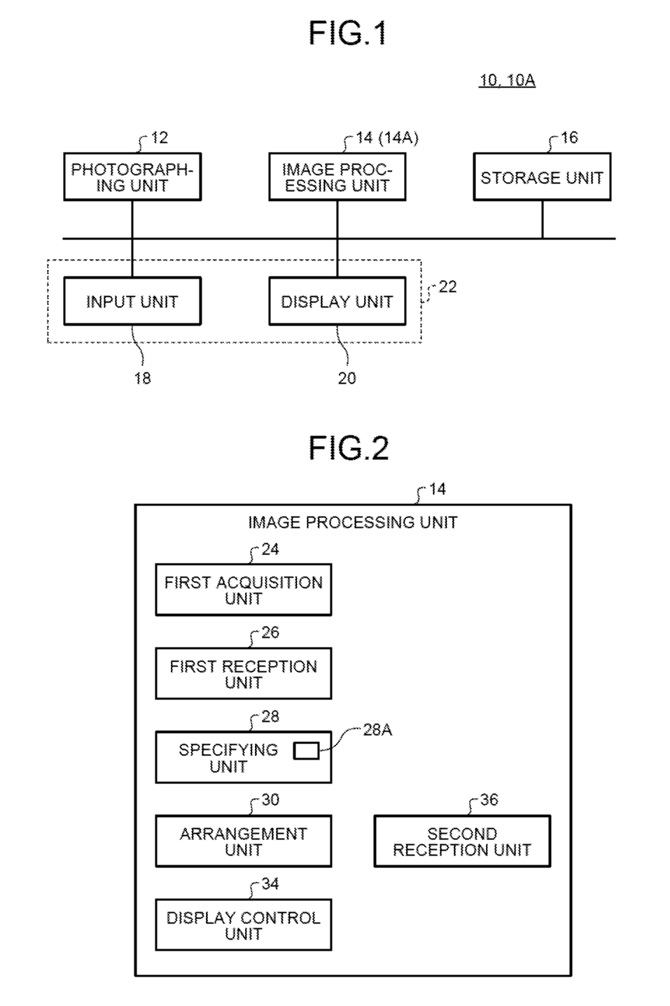

FIG. 1 is a plan view schematically illustrating an image processing apparatus 10 in the embodiment.

The image processing apparatus 10 is an apparatus that displays a preview image on a display unit 20.

The image processing apparatus 10 includes a photographing unit 12, an image processing unit 14, a storage unit 16, an input unit 18, and the display unit 20. The photographing unit 12, the image processing unit 14, the storage unit 16, the input unit 18, and the display unit 20 are electrically connected to one another through a bus.

The image processing apparatus 10 only needs to have a configuration including at least the image processing unit 14 and at least one of the photographing unit 12, the storage unit 16, the input unit 18, and the display unit 20 may be provided as a separate body.

The image processing apparatus 10 may be a mobile terminal that is portable or may be a fixed-type terminal. In the embodiment, the image processing apparatus 10 is a portable terminal including the photographing unit 12, the image processing unit 14, the storage unit 16, the input unit 18, and the display unit 20 integrally, as an example.

The photographing unit 12 photographs an observation environment in a real space in which a preview image is displayed. The observation environment is an environment when a user visually recognizes (observes) an image displayed on the display unit 20. The observation environment may be an environment under which the user observes a recording medium with a document image printed on it. The photographing unit 12 acquires a background image as a photographed image of the observation environment in the real space by photographing. The background image may be a still image or a moving image. In the embodiment, the photographing unit 12 photographs the background images continuously and outputs them to the image processing unit 14 sequentially when supply of electric power to respective apparatus parts of the image processing apparatus 10 is started. Examples of the observation environment in the real space in which the preview image is displayed include offices, exhibition halls, train stations, platforms, and the inside of various buildings. The photographing unit 12 is a well-known photographing device providing a photographed image by photographing. The background image may be an image drawn by computer graphics (CG) and is not limited to the image provided by the photographing unit 12.

The display unit 20 displays images of various types. The display unit 20 is a well-known display device such as a liquid crystal display (LCD). In the embodiment, a preview image, which will be described layer, is displayed on the display unit 20.

In the embodiment, the display unit 20 and the photographing unit 12 are arranged such that a screen of the display unit 20 and the photographing direction of the photographing unit 12 face opposite directions to each other in a housing (not illustrated) of the image processing apparatus 10, as an example. For example, when the image photographed by the photographing unit 12 is displayed on the display unit 20 in a state where the position of the image processing apparatus 10 is fixed, the photographed image displayed on the display unit 20 and a scene in the real space positioned in the background of the display unit 20 (on the opposite side of the screen of the display unit 20) are the same.

The input unit 18 receives operations of various types from the user.

A user interface (UI) unit 22 in which the input unit 18 and the display unit 20 are configured integrally may be employed. The UI unit 22 is a well-known touch panel, for example.

In the embodiment, the UI unit 22 is the touch panel in which the input unit 18 and the display unit 20 are configured integrally.

The storage unit 16 is a storage medium such as a memory and a hard disc drive (HDD) device and stores therein programs of various types and pieces of data of various types for executing pieces of processing, which will be described later.

The image processing unit 14 is a computer configured by including a central processing unit (CPU), a read only memory (ROM), and a random access memory (RAM). It should be noted that the image processing unit 14 may be a circuit other than a general-purpose CPU. The image processing unit 14 controls the respective apparatus parts provided on the image processing apparatus 10.

The image processing unit 14 performs control to display a preview image of a document image on the display unit 20. In the embodiment, the preview image is a superimposition image that is formed by superimposing a two-dimensional document image, which will be described later, based on the document image on the background image. Display processing like this is executed by a three-dimensional (3D) engine such as OpenGL.

The background image is a photographed image of the observation environment in the real space in which the preview image is displayed.

In the embodiment, the preview image is an image obtained by projecting, onto a two-dimensional plane, a three-dimensional model in which the background image is arranged in a virtual three-dimensional space and the document image is arranged on the background image.

Furthermore, although the preview image is the superimposition image formed by superimposing the two-dimensional document image based on the document image on the background image in the embodiment, the preview image only needs to be at least an image formed by arranging the two-dimensional document image on the background image and the preview image may contain another screen.

Although examples of another screen include a screen on which a transparent image formed using a transparent colorant is displayed and a screen on which a surface effect image defining a surface effect to be given to paper using a colorant of a special color (gold, white, transparent, or the like) is displayed, another screen is not limited thereto.

When the preview image includes a plurality of screens, the preview image only needs to be an image formed by arranging the plurality of screens at different positions in the Z-axis direction (direction perpendicular to the screen of the display unit 20.

FIG. 2 is a block diagram illustrating the functional configuration of the image processing unit 14. The image processing unit 14 includes a first acquisition unit 24, a first reception unit 26, a specifying unit 28, an arrangement unit 30, a display control unit 34, and a second reception unit 36.

Some or all of the first acquisition unit 24, the first reception unit 26, the specifying unit 28, the arrangement unit 30, the display control unit 34, and the second reception unit 36 may be made to operate by causing a processing device such as a CPU to execute programs, that is, by software, by hardware such as an integrated circuit (IC), or by software and hardware in combination.

The first acquisition unit 24 acquires the document image. The document image is an image as a preview target. For example, the first acquisition unit 24 reads the document image from the storage unit 16 so as to acquire the document image. For example, the display control unit 34 performs control to display a list of images stored in the storage unit 16 on the display unit 20. A user selects the image as the preview target by operating the input unit 18. The first acquisition unit 24 reads the selected image as the document image so as to acquire the document image. It should be noted that the first acquisition unit 24 may acquire an image photographed by the photographing unit 12 as the document image. Alternatively, the first acquisition unit 24 may acquire an image read by a well-known scanner device (not illustrated) as the document image. In this case, the image processing unit 14 and the scanner device only need to be electrically connected to each other.

The first acquisition unit 24 may acquire, as the background image, an image photographed by the photographing unit 12 as the photographed image of the observation environment in the real space. In the embodiment, the first acquisition unit 24 acquires the background image from the photographing unit 12.

The first reception unit 26 receives specification of a display region of the document image on the screen of the display unit 20 from the user. The screen of the display unit 20 is in a two-dimensional planar form. The user specifies the display region of the document image on the screen of the display unit 20. The first reception unit 26 receives two-dimensional coordinates indicating a position of the specified display region on the screen of the display unit 20 so as to receive specification of the display region.

In the embodiment, the two-dimensional coordinates on the screen of the display unit 20 are received as the specification of the display region. That is to say, the two-dimensional coordinates that are received as the specification of the display region are coordinates on the screen of the display unit 20, that is, on the device. For this reason, the two-dimensional coordinates that are received as the specification of the display region are referred to as device coordinates for explanation, hereinafter.

The shape of the display region of the document image is not limited. For example, the shape of the display region that is specified is a circular shape (true circle, ellipse), a triangular shape, a square shape, a polygonal shape having equal to or more than five vertices, or the like. In the embodiment, the shape of the display region that is specified is a rectangular shape (that is, a square shape) having four vertices, as an example.

That is to say, in the embodiment, the first reception unit 26 receives specification of the rectangular region on the screen of the display unit 20 as the specification of the display region. The first reception unit 26 may receive specification of the four vertices of the rectangular region on the screen of the display unit 20 as the specification of the display region. To be specific, the first reception unit 26 may receive two-dimensional coordinates of the four vertices of the rectangular region on the screen of the display unit 20 as the specification of the display region.

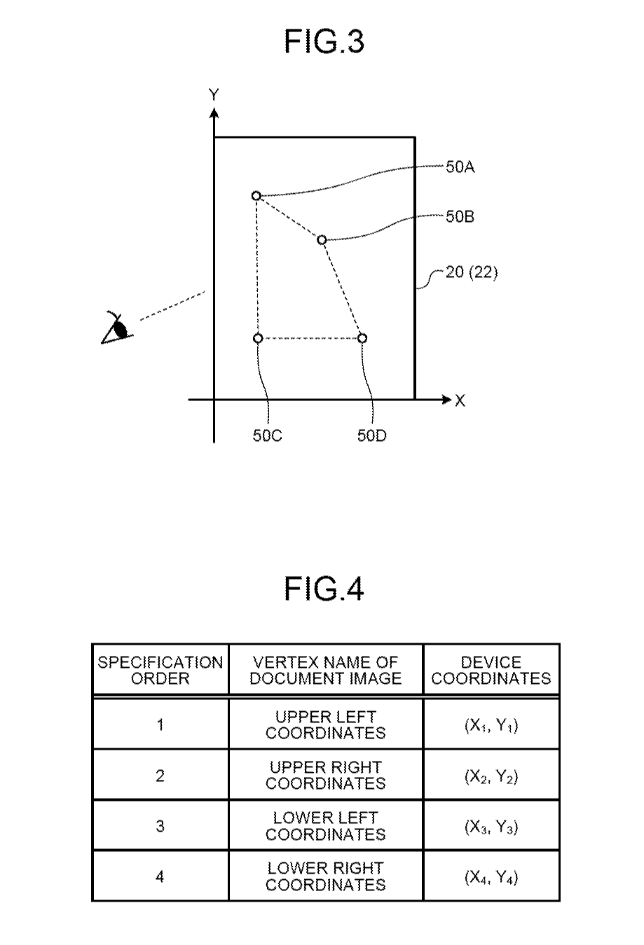

FIG. 3 is a explanatory diagram for explaining the device coordinates and the display region that is specified. The user specifies the four vertices indicating the display region of the document image on the screen of the display unit 20 while referring to the display unit 20, for example. As described above, in the embodiment, the input unit 18 and the display unit 20 integrally configure the touch panel (UI unit 22). The touch panel (UI unit 22) enables the user to specify the display region of the document image on the screen of the display unit 20 by an operation on the screen of the display unit 20.

For example, the image processing unit 14 previously defines a relation between the specification order of the respective vertices of the display region and relative positions of the respective vertices of the square display region. The relative positions of the respective vertices are indicated by upper left coordinates, upper right coordinates, lower left coordinates, and lower right coordinates, for example.

The user specifies each of the four vertices indicating the display region of the document image on the screen of the display unit 20 in accordance with the predetermined specification order. For example, the user sequentially specifies the four vertices of a vertex 50A corresponding to the upper left coordinates, a vertex 50B corresponding to the upper right coordinates, a vertex 50C corresponding to the lower left coordinates, and a vertex 50D corresponding to the lower right coordinates by operating the UI unit 22 (input unit 18). With the specification, the first reception unit 26 receives the device coordinates of the specified four vertices as the specified display region.

In this case, the display control unit 34 may control to display, on the display unit 20, a message (for example, “Next, specify the upper left coordinates”) prompting the user to specify each vertex in accordance with the specification order. Furthermore, when the same device coordinates are continuously specified, the display control unit 34 may control to display a message prompting the user to input the device coordinates again on the display unit 20.

Although details will be described later, the user can specify one vertex of the four vertices and drag it to a desired position, for example.

The specifying unit 28 sets the display region received by the first reception unit 26 as the specified display region. To be specific, the specifying unit 28 stores, in the storage unit 16, the device coordinates of the four vertices of the specified display region as display region information.

FIG. 4 is a view illustrating an example of a data structure of the display region information. The display region information is data in which the specification order, a name of a vertex of the document image, and the specified device coordinates are associated to one another, for example. As the name of the vertex of the document image, each of upper left coordinates, upper right coordinates, lower left coordinates, and lower right coordinates is used in the example as illustrated in FIG. 4.

Referring back to FIG. 2, the specifying unit 28 outputs the device coordinates of the respective vertices of the specified display region as the specified display region to the arrangement unit 30.

It should be noted that the specifying unit 28 may include a one-point selection movement unit 28A.

The one-point selection movement unit 28A reads each of the longitudinal and lateral sizes of the document image from the document image acquired by the first acquisition unit 24. The one-point selection movement unit 28A calculates two-dimensional coordinates (device coordinates) of the four vertices of the document image when the document image having the read sizes is arranged on the screen of the display unit 20 such that the center of the document image and the center of the screen of the display unit 20 are identical to each other.

In this case, the display control unit 34 performs control to display marks indicating the respective four vertices at positions of the calculated device coordinates on the screen of the display unit 20. For example, the display control unit 34 performs control to display marks (for example, circular marks) indicating the respective four vertices at the respective positions corresponding to the calculated device coordinates of the four vertices on the screen of the display unit 20 (see FIG. 3). The display control unit 34 may control to display the document image while the respective four vertices of the document image as the preview target are made identical to the respective positions corresponding to the calculated device coordinates of the four vertices on the screen of the display unit 20.

The user selects one vertex of the four vertices displayed on the display unit 20 and moves it to an arbitrary place on the screen of the display unit 20 by operating the input unit 18. To be specific, the user specifies and drags the vicinity of the one vertex as a target the position of which is to be changed among the four vertices displayed on the display unit 20 so as to move it to an arbitrary position. In this manner, the user can change the display region.

The first reception unit 26 receives selection and movement of the one vertex of the four vertices of the rectangular region, and receives a rectangular region containing, as vertices, the one vertex after being moved and other three vertices as the specification of the display region.

In this case, the one-point selection movement unit 28A only needs to set the vertex closest to the position specified by the user among the four vertices displayed on the display unit 20 to the selected one vertex. For example, it is assumed that the device coordinates of the position specified by the user on the screen of the display unit 20 are (Xₐ, Yₐ). In this case, the one-point selection movement unit 28A calculates a distance to one vertex (X₁, Y₁) of the four vertices from the device coordinates (Xₐ, Yₐ) using the following equation (1).

\sqrt{(Xₐ−X₁)²+(Yₐ−Y₁)²} (1)

The one-point selection movement unit 28A calculates respective distances to the other three vertices (X₂, Y₂), (X₃, Y₃), and (X₄, Y₄) from the device coordinates (Xₐ, Yₐ) of the specified one vertex in the same manner so as to set the closest vertex among the four vertices to the one vertex selected by the user.

For example, the one vertex (X₁, Y₁) of the four vertices is assumed to be one vertex closest to the device coordinates (Xₐ, Yₐ). In this case, the one-point selection movement unit 28A stores the device coordinates (Xₐ, Yₐ) initially specified by the user and the device coordinates (X₁, Y₁) of the one vertex closest to the device coordinates in the storage unit 16 in association with each other.

Thereafter, the user drags the position of the device coordinates (Xₐ, Yₐ) of the selected one vertex by an operation instruction using the input unit 18. The first reception unit 26 acquires the device coordinates that are being dragged. The device coordinates that are being dragged are assumed to be (X_{b}, Y_{b}). The device coordinates can be expressed by (X₁+X_{b}−Xₐ, Y₁+Y_{b}−Yₐ) after the one vertex (X₁, Y₁) closest to the device coordinates initially specified by the user is moved.

The one-point selection movement unit 28A sets, as the specified display region, a rectangular region defined by the device coordinates (X₂, Y₂), (X₃, Y₃), and (X₄, Y₄) of the three vertices other than the selected one vertex and the device coordinates (X₁+X_{b}−Xₐ, Y₁+Y_{b}−Yₐ) of the one vertex after being moved in accordance with the instruction using the input unit 18 by the user.

In this case, the one-point selection movement unit 28A may sequentially output the device coordinates that are being dragged to the arrangement unit 30. With processing by the arrangement unit 30, which will be described later, the user can adjust the display region while referring to a two-dimensional document image having a size and a shape in accordance with the specified display region that is contained in the preview image.

When the first acquisition unit 24 has acquired the background image, a superimposition image formed by superimposing, on the background image, a two-dimensional document image based on the document image adjusted to have the shape, the position, and the size of the display region that is being adjusted is displayed on the display unit 20. This display enables the user to specify the display region in an arbitrary region on the background image while referring to the two-dimensional document image displayed on the display unit 20.

When the display control unit 34 performs control to display an image indicating the display region specified by the user on the screen of the display unit 20, it performs control to preferably display the image indicating the display region at a position moved from the device coordinates specified by the user by an amount of a relative position on the screen. This display manner prevents the place specified by the user on the screen of the display unit 20 from being hidden by fingers of the user, a pointer device, or the like and enables the user to easily specify the display region.

The positions (positions of the four vertices, for example) specified by the user and the display position of the image indicating the specified display region on the screen of the display unit 20 are not limited to be completely identical to each other.

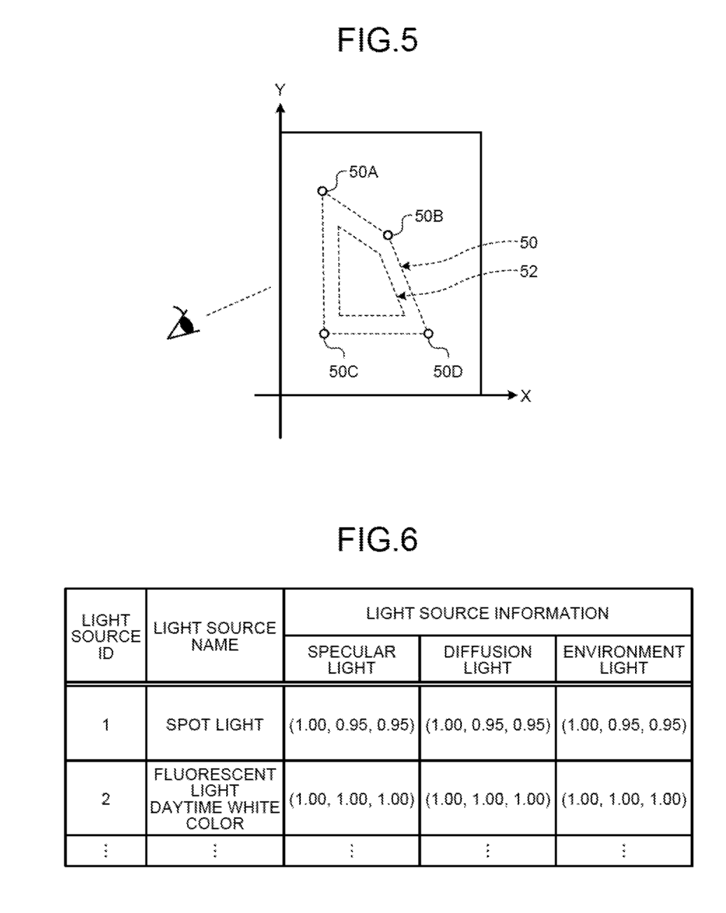

FIG. 5 is a view illustrating an example of a relation between the four vertices of the display region specified by the user and the image indicating the display region. As illustrated in FIG. 5, the respective device coordinates of the four vertices (50A, 50B, 50C, 50D) specified as a display region 50 by the user and the device coordinates of four vertices of an image 52 displaying the display region may be different from each other.

That is to say, the positions of the four vertices of the display region 50 specified by the user and the positions of the four vertices of the image 52 displaying the display region 50 may not be necessarily identical to each other as long as the respective device coordinates of the four vertices of the image indicating the display region that is displayed on the display unit 20 can be calculated from the respective device coordinates of the four vertices specified by the user.

In this case, for example, the specifying unit 28 calculates the device coordinates of a center of gravity of the four vertices from the respective device coordinates of the four vertices of the display region 50 specified by the user. Then, the specifying unit 28 multiples vectors heading to the respective four vertices from the center of gravity by a constant number so as to calculate the device coordinates of the four vertices of the image indicating the display region 50 that is displayed on the display unit 20. For example, even when an image in which the four vertices of the specified display region 50 are emphasized is displayed on the display unit 20, an influence on appearance of the image of the display region 50 that is being adjusted can be reduced.

It should be noted that the document image as the display target is generally a square shape like an oblong shape. The preview image having a shape other than the square shape is, however, desired to be displayed in some cases. That is to say, a shape other than the square shape, such as a circular shape, is specified as the display region in some cases. In such a case, the display control unit 34 only needs to execute transmission processing of adding alpha values indicating transmittance to pixel values of respective pixels on the document image and adjusting the alpha values of the pixel values on a portion that is not used to values indicating complete transmission. A graphic engine by the display control unit 34 can process the transmission processing. This processing enables display regions having various shapes to be handled.

Referring back to FIG. 2, the second reception unit 36 receives light source information and document reflection information. The light source information is information indicating reflection characteristics of a virtual light source that is arranged in a virtual three-dimensional space. The document reflection characteristics are information indicating reflection characteristics in accordance with a type of a recording medium. For example, the second reception unit 36 previously stores a light source information table and a document reflection information table in the storage unit 16. The second reception unit 36 receives the light source information and the document reflection information that have been selected from the light source information table and the document reflection information table, respectively, by an operation instruction using the input unit 18 by the user.

FIG. 6 is a view illustrating a data structure of the light source information table. The light source information table is information in which a light source ID for identifying a type of the light source, a light source name, and light source information are associated to one another. It should be noted that the light source information table may be a database and a data format thereof is not limited.

The light source information is information indicating light attribute of the light source that is identified by the corresponding light source ID. The light attribute is information for identifying a reflection amount in order to produce light at the time of display of the preview image. The light source information is expressed by light amounts (brightness) for respective color components of RGB in each of specular light, diffusion light, and environment light as items related to a color temperature of the light source. A value of light for each of the color components of RGB is “1.0” at maximum and “0” at minimum. To be specific, in FIG. 6, “(1.00, 0.95, 0.95)” illustrated as an example of the values of the specular light indicates that light amounts of the specular light for the R component, the G component, and the B component are 1.00, 0.95, and 0.95, respectively.

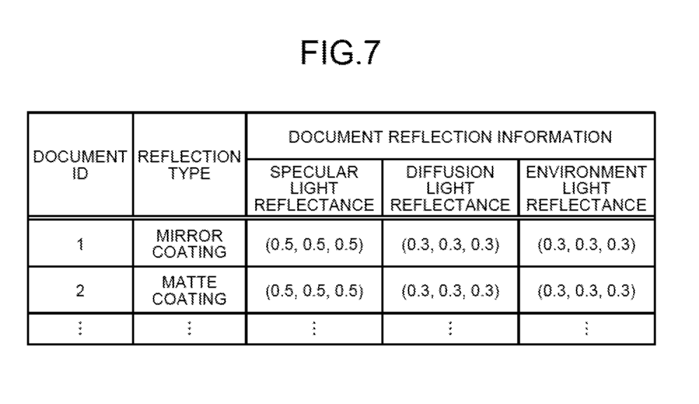

FIG. 7 is a view illustrating an example of a data structure of the document reflection information table. The document reflection information table contains a document ID for identifying a type of a recording medium, a reflection type, and document reflection information. The reflection type indicates a type of reflection for a recording medium of a type that is identified by the corresponding document ID. That is to say, reflectance is different depending on types of paper quality of recording media. The document reflection information contains specular light reflectance, diffusion light reflectance, and environment light reflectance. The specular light reflectance is reflectance at which an incidence angle and a reflection angle are equal to each other. The diffusion light reflectance is reflectance at which irregular reflection is made. The environment light reflectance is reflectance of light that is obtained by repeating irregular reflection. In the embodiment, the values of the respective components of RGB define the reflectance of each of the specular light reflectance, the diffusion light reflectance, and the environment light reflectance. To be specific, in FIG. 7, “(0.5, 0.5, 0.5)” illustrated as an example of the values of the specular light reflectance indicates that the specular light reflectance for each of the R component, the G component, and the B component is “0.5”.

The reflection amount in order to produce light at the time of display of the preview image is defined by a multiplication value obtained by multiplying a light amount (light source information) of the light source by reflectance of an object (reflectance indicated by the document reflection information in FIG. 7). Alternatively, OpenGL may be made to calculate the reflection amount while a coordinate position of the light source in the virtual three-dimensional space is added to the light source information.

The display control unit 34 reads the light source information table that is stored in the storage unit 16 and displays the list of pieces of light source information that are registered in the light source information table on the display unit 20 in a selectable manner. The user inputs light source information corresponding to a desired light source name from the list of the pieces of light source information displayed by an operation instruction using the input unit 18. With this, the second reception unit 36 receives the light source information.

In the same manner, the display control unit 34 reads the document reflection information table stored in the storage unit 16 and displays a list of pieces of document reflection information that are registered in the document reflection information table on the display unit 20 in a selectable manner. The user inputs document reflection information corresponding to a desired reflection type from the list of the pieces of document reflection information displayed by an operation instruction using the input unit 18. With this, the second reception unit 36 receives the document reflection information.

New light source information and new document reflection information may be registered in the document information table and the document reflection information table, respectively, and these registered pieces of information may be made capable of being edited by an operation instruction using the input unit 18.

Referring back to FIG. 2, the arrangement unit 30 will be described next.

The arrangement unit 30 calculates a virtual region corresponding to the specified display region in the virtual three-dimensional space. As described above, the virtual region is expressed by two-dimensional coordinates (device coordinates) specified on the two-dimensional screen of the display unit 20. The arrangement unit 30 calculates the virtual region indicating three-dimensional coordinates, an inclination, a position, and the like of the display region 50 when the display region 50 expressed by the two-dimensional coordinates is arranged in the virtual three-dimensional space.

First, outline of processing by the arrangement unit 30 is described. The arrangement unit 30 calculates the virtual region corresponding to the specified display region 50 in the virtual three-dimensional space using a projection matrix for projecting a document plane temporarily arranged at a predetermined reference position in the virtual three-dimensional space onto a two-dimensional space on the screen of the display unit 20, the two-dimensional coordinates of the specified display region 50, and the document image.

The document plane temporarily arranged in the virtual three-dimensional space indicates an image obtained by temporarily arranging, based on the longitudinal and lateral lengths of the document image as the preview target, the four vertices of the document image having the size and the shape in the virtual three-dimensional space. That is to say, the document plane indicates the document image temporarily arranged in the virtual three-dimensional space. In the embodiment, the document plane is rectangular.

The reference position in the virtual three-dimensional space means an XY plane with Z=0 in the virtual three-dimensional space. The position of Z=0 corresponds to a position of a virtual camera photographing the virtual three-dimensional space in OpenGL and the −Z-axis direction means the opposite direction (opposite direction by 180°) to the photographing direction of the virtual camera.

Then, the arrangement unit 30 calculates an inclination and position matrix using the device coordinates of the four vertices of the display region 50 specified by the user, the coordinates of the four vertices of the document plane temporarily arranged in the virtual three-dimensional space, and the projection matrix for projecting the document plane temporarily arranged in the virtual three-dimensional space onto the two-dimensional space.

The inclination and position matrix is a matrix that is used to calculate the inclination and the position (depth) of the document image arranged in the virtual region corresponding to the specified display region 50 in the virtual three-dimensional space.

The arrangement unit 30 calculates the three-dimensional coordinates of the four vertices of the virtual region corresponding to the specified display region 50 in the three-dimensional space by applying the three-dimensional coordinates of the four vertices of the document plane temporarily arranged in the virtual three-dimensional space to the inclination and position matrix.

With this processing, the arrangement unit 30 calculates the virtual region corresponding to the specified display region 50 in the virtual three-dimensional space.

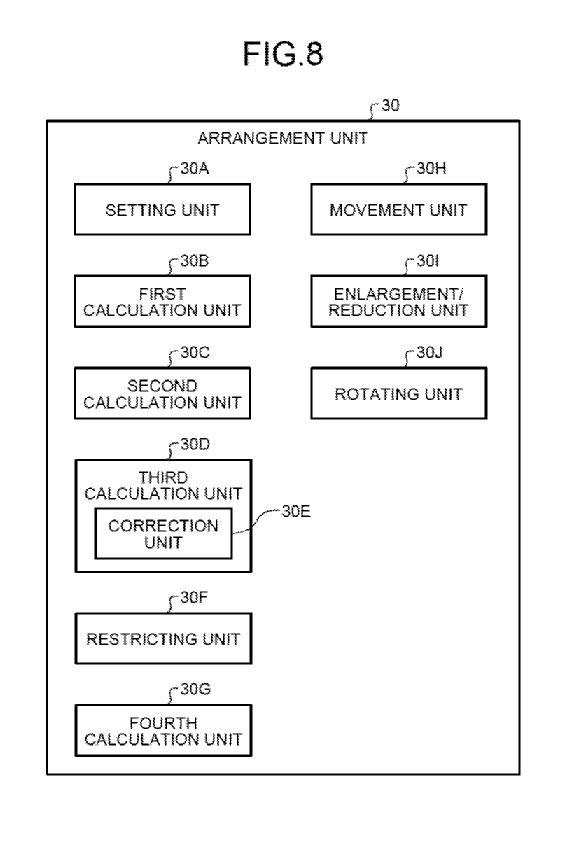

FIG. 8 is a functional block diagram of the arrangement unit 30. The arrangement unit 30 includes a setting unit 30A, a first calculation unit 30B, a second calculation unit 30C, a third calculation unit 30D, a restricting unit 30F, a fourth calculation unit 30G, a movement unit 30H, an enlargement/reduction unit 30I, and a rotating unit 30J.

Some or all of the setting unit 30A, the first calculation unit 30B, the second calculation unit 30C, the third calculation unit 30D, the restricting unit 30F, the fourth calculation unit 30G, the movement unit 30H, the enlargement/reduction unit 30I, and the rotating unit 30J may be made to operate by causing a processing device such as the CPU to execute programs, that is, by software, by hardware such as an IC, or by software and hardware in combination.

The setting unit 30A acquires the display region 50 set by the specifying unit 28. To be specific, the setting unit 30A acquires the device coordinates (two-dimensional coordinates) of the respective vertices of the display region 50 specified by the user.

The setting unit 30A acquires the longitudinal and lateral sizes of the document image as the preview target.

The setting unit 30A temporarily arranges the document plane having the longitudinal and lateral sizes of the document image as the preview target on the XY plane with Z=0 in the virtual three-dimensional space. In other words, the setting unit 30A first temporarily arranges the document image as the preview target on the XY plane with Z=0 in the three-dimensional space so as to provide the document plane temporarily arranged in the virtual three-dimensional space.

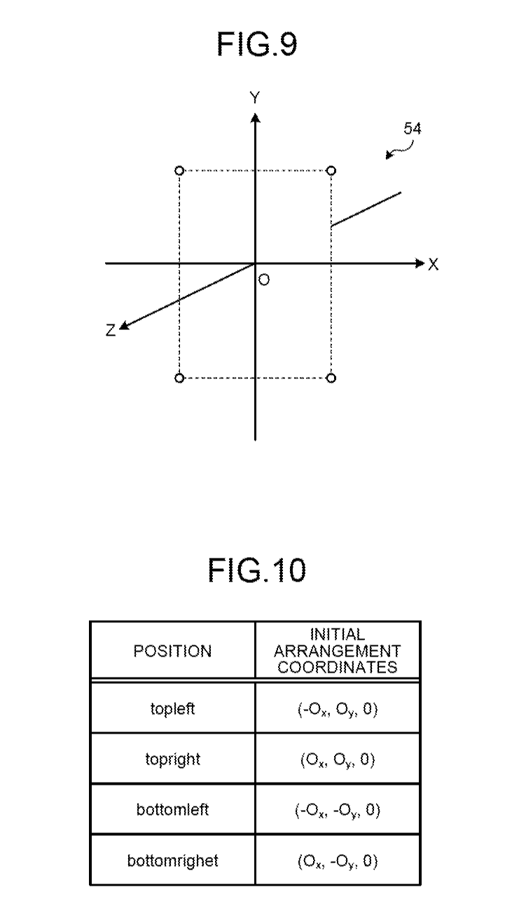

FIG. 9 is a explanatory diagram for explaining a document plane 54 temporarily arranged in the virtual three-dimensional space. The setting unit 30A superimposes the center of the document plane 54 on a point of origin O of the XY plane in the virtual three-dimensional space and sets the coordinates (three-dimensional coordinates) of the four vertices of the document plane 54 as initial values so as to temporarily arrange the document plane 54.

It is assumed that the lateral width of the document image is a width, the height thereof is a height, Oₓ is width/2, and O_{y} is height/2. Under this assumption, initial arrangement coordinates of the respective four vertices of the temporarily arranged document plane 54 in the virtual three-dimensional space are the values as illustrated in FIG. 10.

As illustrated in FIG. 10, for example, the initial arrangement coordinates of the respective four vertices (upper left (topleft), upper right (topright), lower left (bottomleft), lower right (bottomright)) of the temporarily arranged document plane 54 are the values as illustrated in FIG. 10.

The setting unit 30A holds the initial arrangement coordinates of the temporarily arranged document plane 54.

Referring back to FIG. 8, the first calculation unit 30B calculates a projection matrix F.

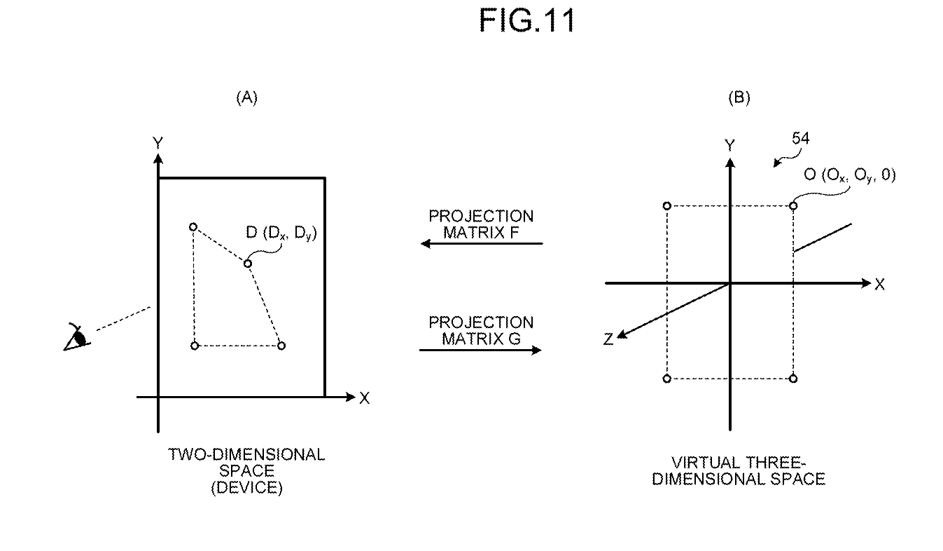

FIG. 11 is an explanatory diagrams for explaining calculation of the projection matrix F and a projection matrix G. The projection matrix F is a projection matrix for projecting the initial arrangement coordinates (see (B) in FIG. 11) of the document plane 54 temporarily arranged in the virtual three-dimensional space onto the device coordinates (see (A) in FIG. 11) in the two-dimensional space.

That is to say, the first calculation unit 30B calculates the projection matrix F for projecting the initial arrangement coordinates (Oₓ, OY, 0) of an upper right (topright) vertex O on the document plane 54 temporarily arranged in the virtual three-dimensional space onto the device coordinates (Dₓ, D_{y}) of one vertex D in the two-dimensional space.

Furthermore, the first calculation unit 30B calculates the projection matrix G for performing inverse projection. That is to say, the first calculation unit 30B calculates the projection matrix G for projecting the device coordinates in the two-dimensional space onto the initial arrangement coordinates of the document plane 54 temporarily arranged in the virtual three-dimensional space.

As described above, in the embodiment, display processing using OpenGL is performed. In the embodiment, the first calculation unit 30B calculates the projection matrix F and the projection matrix G in accordance with a conversion stage by OpenGL.

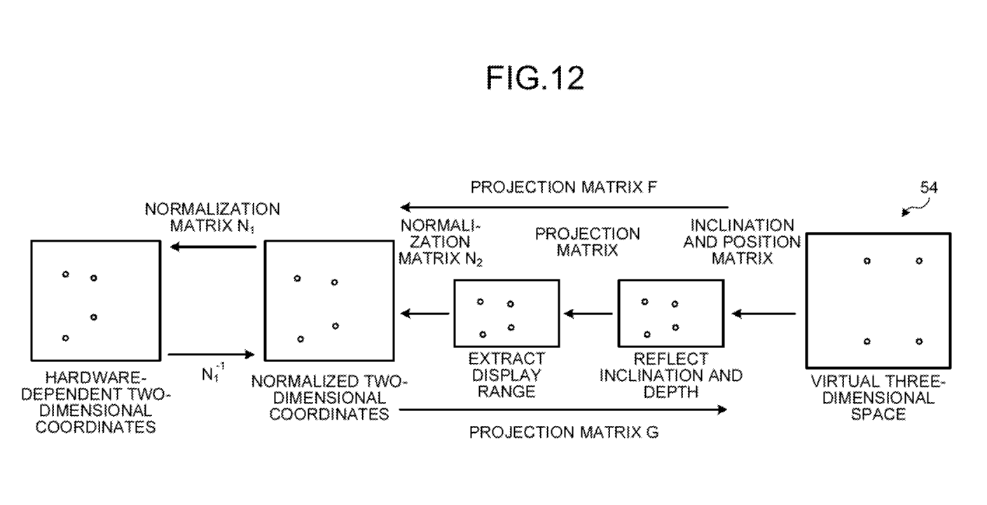

FIG. 12 is am explanatory diagram for explaining a relation between the conversion stage by OpenGL and the projection matrices. The first calculation unit 30B converts the device coordinates (see hardware-dependent two-dimensional coordinates in FIG. 12) in the two-dimensional space to normalized two-dimensional coordinates by an inverse matrix N₁⁻¹ of a normalization matrix N₁, and then, calculates the projection matrix F and the projection matrix G in accordance with the conversion stage by OpenGL. The first calculation unit 30B only needs to calculate the projection matrix F and the projection matrix G using a well-known calculation formula for calculating the projection matrix or an arbitrary equivalent calculation formula. The first calculation unit 30B may calculate the projection matrix F and the projection matrix G using a computer vision library such as an open source computer vision library (openCV).

The projection matrix F and the projection matrix G that are calculated by the first calculation unit 30B are as follows.

$$\begin{matrix}F = ≅ ( \begin{matrix}{f}_{11} & {f}_{12} & {f}_{13} & {f}_{14} \\ {f}_{21} & {f}_{22} & {f}_{23} & {f}_{24} \\ {f}_{31} & {f}_{32} & {f}_{33} & {f}_{34}\end{matrix} ) = ( \begin{matrix}{f}_{1} & {f}_{2} & {f}_{3} & {f}_{4}\end{matrix} ) & ( 2 ) \\ G ≅ ( \begin{matrix}{g}_{11} & {g}_{12} & {g}_{13} & {g}_{14} \\ {g}_{21} & {g}_{22} & {g}_{23} & {g}_{24} \\ {g}_{31} & {g}_{32} & {g}_{33} & {g}_{34}\end{matrix} ) & ( 3 )\end{matrix}$$

The equation (2) indicates the projection matrix F. The equation (3) indicates the projection matrix G. The projection matrix has indefiniteness of constant multiplication by the definition thereof. The projection matrix therefore provides the same conversion even when it is multiplied by an arbitrary scale coefficient (value other than 0). It should be noted that vectors of three lines and one row are expressed as f1, f2, f3, and f4 from the left for the projection matrix F.

The second calculation unit 30C calculates the inclination and position matrix. As described above, the inclination and position matrix is a matrix that is used to calculate the inclination and the position (depth) of the document image arranged in the virtual region corresponding to the specified display region 50 in the virtual three-dimensional space.

The second calculation unit 30C acquires the projection matrix F from the first calculation unit 30B. The second calculation unit 30C acquires optical characteristic parameters of the photographing unit 12. The optical characteristic parameters of the photographing unit 12 are parameters such as a focal length of the photographing unit 12, and a width and a height for one pixel, an image center, and a pixel-based focal length (distance to an image plane from the lens center) in a charge coupled device (CCD) image sensor. The storage unit 16 previously stores therein the optical characteristic parameters of the photographing unit 12. The second calculation unit 30C only needs to read the optical characteristic parameters from the storage unit 16.

The second calculation unit 30C calculates the inclination and position matrix using the projection matrix F and the optical characteristic parameters of the photographing unit 12. In the embodiment, the second calculation unit 30C calculates the inclination and position matrix using the projection matrix F and a projection matrix A, which will be described later.

First, the second calculation unit 30C calculates a projection matrix (hereinafter, referred to as projection matrix A) for projecting a three-dimensional image arranged in the virtual three-dimensional space onto a two-dimensional image (that is, projecting three-dimensional coordinates in the virtual three-dimensional space onto two-dimensional coordinates in the two-dimensional space) from the optical characteristic parameters of the photographing unit 12. The projection matrix A is expressed by the following equation (4).

$$A = ( \begin{matrix}{a}_{x} & 0 & {c}_{x} \\ 0 & {a}_{y} & {c}_{y} \\ 0 & 0 & 1\end{matrix} ) \qquad ( 4 )$$

In the equation (4), aₓ and a_{y} indicate the focal length of the photographing unit 12. To be specific, aₓ and a_{y} indicate a distance to a plane on which the CCD is arranged from the lens center of the photographing unit 12. cₓ and c_{y} indicate a principal point, and indicate the image center in the embodiment. The image center indicates the center of a two-dimensional photographed image obtained by photographing.

The second calculation unit 30C preferably calculates the projection matrix A using the optical characteristic parameters of the photographing unit 12 when the background image to be used for generating the preview image is acquired. Usage of the projection matrix A calculated from the optical characteristic parameters of the photographing unit 12 can provide a two-dimensional document image contained in the preview image under the same optical conditions as photographing conditions of the background image. That is to say, conversion into the two-dimensional image can be performed in the same manner as that for an object reflected into the background image.

In the embodiment, the second calculation unit 30C previously calculates the projection matrix A from the optical characteristic parameters of the photographing unit 12 that is mounted on the image processing apparatus 10 and previously stores it in the storage unit 16. Alternatively, a plurality of projection matrices A calculated using the respective optical characteristic parameters of a plurality of photographing units 12 that photograph the background images may be previously stored in the storage unit 16. In this case, the image processing unit 14 may display the plurality of projection matrices A on the display unit 20 in such a manner that the user can select the projection matrix A, and the second calculation unit 30C may employ the projection matrix A selected by an operation instruction using the input unit 18 by the user. Furthermore, the user may set an arbitrary characteristic parameter and the projection matrix A by an operation instruction using the input unit 18.

The second calculation unit 30C calculates the inclination and position matrix using the projection matrix F and the projection matrix A. For example, the second calculation unit 30C calculates the inclination and position matrix from the projection matrix F and the projection matrix A using a homography decomposition method. When the homography decomposition method is used, a value is not settled or a complex root is provided in some cases. The inclination and position matrix is expressed by an equation (5).

$$( \begin{matrix}{r}_{11} & {r}_{12} & {r}_{13} & {t}_{x} \\ {r}_{21} & {r}_{22} & {r}_{23} & {t}_{y} \\ {r}_{31} & {r}_{32} & {r}_{33} & {t}_{z}\end{matrix} ) = [ \begin{matrix}{r}_{1} & {r}_{2} & {r}_{3} & t\end{matrix} ] \qquad ( 5 )$$

In the equation (5), vectors of three lines and one row in the inclination and position matrix are expressed as γ₁, γ₂, γ₃, and t from the left. It should be noted that γ₃ is a cross product of γ₁ and γ₂.

The second calculation unit 30C calculates the inclination and position matrix using the following equation (6).

$$\begin{matrix}[ \begin{matrix}{r}_{1} & {r}_{2} & {r}_{3} & t\end{matrix} ] = [ \begin{matrix}\frac{{A}^{- 1} {f}_{1}}{{μ}_{1}} & \frac{{A}^{- 1} {f}_{2}}{{μ}_{2}} & r \times r & \frac{{A}^{- 1} {f}_{4}}{{μ}_{1}}\end{matrix} ] & ( 6 ) \\ {μ}_{1} = ‖ {A}^{- 1} {f}_{1} ‖ & ( 7 ) \\ {μ}_{2} = ‖ {A}^{- 1} {f}_{2} ‖ & ( 8 )\end{matrix}$$

μ₁ in the equation (6) can be expressed by the equation (7). μ₂ in the equation (6) can be expressed by the equation (8).

In the embodiment, the second calculation unit 30C uses OpenGL. The second calculation unit 30C calculates, as the inclination and position matrix, a matrix obtained by adding a row vector (0, 0, 0, 1) to the inclination and position matrix as indicated by the equation (5) so as to convert the matrix into a 4×4 matrix (see equation (9)).

$$Inclination and position matrix = ( \begin{matrix}{r}_{11} & {r}_{12} & {r}_{13} & {t}_{x} \\ {r}_{21} & {r}_{22} & {r}_{23} & {t}_{y} \\ {r}_{31} & {r}_{32} & {r}_{33} & {t}_{s} \\ 0 & 0 & 0 & 1\end{matrix} ) \qquad ( 9 )$$

The second calculation unit 30C holds the calculated inclination and position matrix (see, the above equation (9)). The second calculation unit 30C also holds the previously calculated inclination and position matrix.

Then, the second calculation unit 30C outputs the calculated inclination and position matrix, the projection matrix F, and the optical characteristic parameters used for calculation to the third calculation unit 30D.

The third calculation unit 30D calculates a projection matrix B for projecting the three-dimensional image arranged in the virtual three-dimensional space onto a two-dimensional image (that is, projecting the three-dimensional coordinates in the virtual three-dimensional space onto two-dimensional coordinates in the two-dimensional space).

Even a matrix obtained by multiplying the inclination and position matrix by the projection matrix A calculated from the optical characteristic parameters is not identical to the projection matrix F. The third calculation unit 30D calculates the projection matrix B such that a multiplication result obtained by multiplying the inclination and position matrix by the projection matrix B is identical to the projection matrix F. A correction matrix of three lines and three rows for making a multiplication value calculated by multiplying the inclination and position matrix by the projection matrix B identical to the projection matrix F is assumed to be M. The third calculation unit 30D derives the following equation (10) and equation (11) by the homography decomposition method so as to calculate the correction matrix M by an equation (15).

$$\begin{matrix}λ [ \begin{matrix}{f}_{1} & {f}_{2} & {f}_{4}\end{matrix} ] = A \cdot [ \begin{matrix}\frac{{A}^{- 1} {f}_{1}}{{μ}_{1}} & \frac{{A}^{- 1} {f}_{2}}{{μ}_{1}} & \frac{{A}^{- 1} {f}_{4}}{{μ}_{1}}\end{matrix} ] & ( 10 ) \\ λ [ \begin{matrix}{f}_{1} & {f}_{2} & {f}_{4}\end{matrix} ] = AM \cdot [ \begin{matrix}\frac{{A}^{- 1} {f}_{1}}{{μ}_{1}} & \frac{{A}^{- 1} {f}_{2}}{{μ}_{2}} & \frac{{A}^{- 1} {f}_{4}}{{μ}_{1}}\end{matrix} ] & ( 11 ) \\ {μ}_{1} = ‖ {A}^{- 1} {f}_{1} ‖ & ( 12 ) \\ {μ}_{2} = ‖ {A}^{- 1} {f}_{2} ‖ & ( 13 ) \\ λ = \frac{1}{‖ {A}^{- 1} {f}_{1} ‖} & ( 14 ) \\ M = {[ \begin{matrix}\frac{{A}^{- 1} {f}_{1}}{{μ}_{1}} & \frac{{A}^{- 1} {f}_{2}}{{μ}_{1}} & \frac{{A}^{- 1} {f}_{4}}{{μ}_{1}}\end{matrix} ] [ \begin{matrix}\frac{{A}^{- 1} {f}_{1}}{{μ}_{1}} & \frac{{A}^{- 1} {f}_{2}}{{μ}_{2}} & \frac{{A}^{- 1} {f}_{4}}{{μ}_{1}}\end{matrix} ]}^{- 1} & ( 15 )\end{matrix}$$

In the equation (10) and the equation (11), μ₁ is expressed by the equation (12) and μ₂ is expressed by the equation (13). Furthermore, in the equation (10) and the equation (11), γ is expressed by the equation (14).

The projection matrix B can be therefore expressed by an equation (16).

B=AM (16)

The third calculation unit 30D converts the projection matrix A and the correction matrix M in the equation (16) into those as indicated by an equation (17) for OpennGL.

$$B = ( \begin{matrix}{a}_{x} & 0 & 0 & 0 \\ 0 & {a}_{y} & 0 & 0 \\ 0 & 0 & \frac{n + f}{n - f} & - \frac{2 fn}{f - n} \\ 0 & 0 & - 1 & 0\end{matrix} ) = ( \begin{matrix}{m}_{11} & {m}_{12} & {m}_{13} & 0 \\ {m}_{21} & {m}_{22} & {m}_{23} & 0 \\ {m}_{31} & {m}_{32} & {m}_{33} & 0 \\ 0 & 0 & 0 & 1\end{matrix} ) \qquad ( 17 )$$

In the equation (17), n and f define a projection range in the z-axis direction on OpenGL. To be specific, n indicates a closer clip distance along the negative z-axis direction. f indicates a farther clip distance along the negative z-axis direction.

The projection matrix B calculated by the third calculation unit 30D is used as the projection matrix for projecting the three-dimensional image arranged in the virtual three-dimensional space onto the two-dimensional image (that is, projecting the three-dimensional coordinates in the virtual three-dimensional space onto the two-dimensional coordinates in the two-dimensional space). By using the projection matrix B, the display control unit 34, which will be described later, projects the document plane 54 arranged in the virtual three-dimensional space onto the display region 50 specified by the device coordinates.

The third calculation unit 30D calls a correction unit 30E in accordance with an operation instruction using the input unit 18 by the user. That is to say, the third calculation unit 30D includes the correction unit 30E.

The projection matrix B calculated by the third calculation unit 30D can take a value that is significantly different from the optical characteristic parameter. When each of values of respective elements as indicated by the projection matrix B is deviated from a predetermined range, the correction unit 30E corrects each of the elements of the projection matrix B such that each of the values of the respective elements is within the predetermined range.

For example, when an element on a first line and a first row of the projection matrix B and an element on a second line and a second row of the projection matrix B vary from the initial projection matrix B by 10% or more, the correction unit 30E corrects the values of the elements of the matrix such that they vary within 10% at maximum. The initial projection matrix B indicates a matrix at a time point at which a similar region to a region of the document plane obtained by temporarily arranging the document image at the predetermined reference position in the virtual three-dimensional space initially is temporarily arranged in the two-dimensional space on the screen of the display unit 20.

For example, the correction unit 30E may execute the correction in accordance with the operation instruction by the user after completion of arrangement while the correction is not performed until the display region 50 is arranged in a region desired by the user on the screen of the display 20 by an operation instruction by the user.

The initial optical characteristic parameter of the photographing unit 12 can be used as the projection matrix by setting the upper limit of variation of the element on the first line and the first row and the element on the second line and the second row of the projection matrix B to 0%. The processing can reduce a feeling of strangeness due to conversion into the two-dimensional image that is different from the object reflected in the background image in movement processing by the movement unit 30H, which will be described later.

The third calculation unit 30D holds two projection matrices B of the projection matrix B calculated previously and the projection matrix B calculated at this time. Furthermore, the third calculation unit 30D outputs the projection matrix B calculated at this time to the restricting unit 30F.

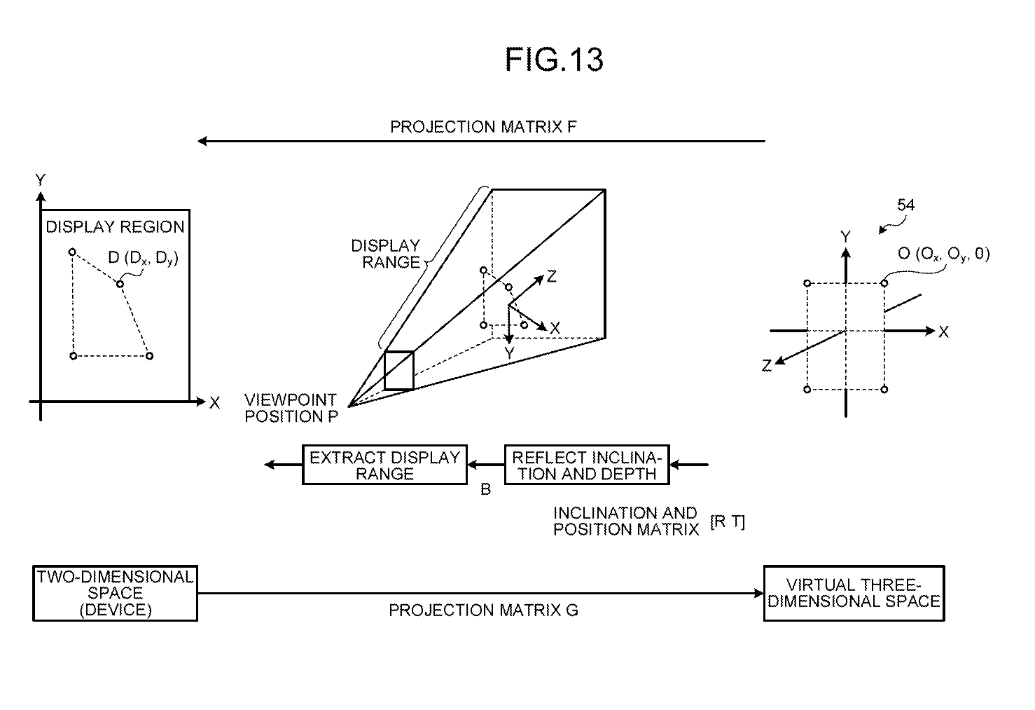

FIG. 13 is am explanatory diagram for explaining a relation among the device coordinates, the inclination and position matrix, and the projection matrix B.

As illustrated in FIG. 13, the inclination and position matrix is a matrix for calculating the inclination and the position (depth) of the document image arranged in the virtual region corresponding to the specified display region 50 in the virtual three-dimensional space. The inclination and the position (depth) corresponding to the specified display region 50 can be reflected by applying the inclination and position matrix to the coordinates of the four vertices of the document plane 54 temporarily arranged in the three-dimensional virtual space. The projection matrix B is used for projecting the three-dimensional image arranged in the virtual three-dimensional space onto a two-dimensional image (that is, projecting the three-dimensional coordinates in the virtual three-dimensional space onto two-dimensional coordinates in the two-dimensional space).

Referring back to FIG. 8, the restricting unit 30F determines whether the shape of the display region 50 specified by the user is actually an impossible shape. When the shape of the display region 50 is determined to be actually an impossible shape, the restricting unit 30F performs control to use the previously specified display region 50.

The actually impossible shape includes a case where the total value of inner angles of the specified display region 50 is equal to or larger than 180° and a case where a position of the virtual region corresponding to the specified display region in the virtual three-dimensional space is located in the direction toward the viewpoint position (the +Z-axis direction) from a point of origin in the depth direction in the virtual three-dimensional space (that is, the above-mentioned reference position in the virtual space).

To be specific, the restricting unit 30F acquires the initial arrangement coordinates of the four vertices of the temporarily arranged document plane 54 from the setting unit 30A. The restricting unit 30F acquires the latest projection matrix B from the second calculation unit 30C and acquires the inclination and position matrix from the second calculation unit 30C. As illustrated in FIG. 12, the restricting unit 30F calculates the normalized two-dimensional coordinates of the respective four vertices from the initial arrangement coordinates of the four vertices of the temporarily arranged document plane 54, the inclination and position matrix, and the projection matrix B. In this case, when Z coordinates (coordinates in the depth direction) of the normalized two-dimensional coordinates of the all four vertices are equal to or larger than 0, that is, when they are located at the rear of the virtual camera photographing the virtual three-dimensional space (opposite to the photographing direction, that is, in the direction toward the viewpoint position from the point of origin in the depth direction in the virtual three-dimensional space), the restricting unit 30F determines an abnormality. The virtual camera is arranged at the point of origin in the virtual three-dimensional space and the −Z-axis direction is set to the photographing direction.

Referring back to FIG. 8, the fourth calculation unit 30G determines whether the restricting unit 30F has determined an abnormality. When the restricting unit 30F has determined an abnormality, the fourth calculation unit 30G notifies the specifying unit 28 (see FIG. 2), the second calculation unit 30C, and the third calculation unit 30D of an abnormal signal.

The specifying unit 28 rewrites the latest specified display region 50 by the previously specified display region 50 when it has received the abnormal signal. The second calculation unit 30C rewrites the latest inclination and position matrix by the previously calculated inclination and position matrix when it has received the abnormal signal. The correction unit 30E rewrites the latest projection matrix B by the previously calculated projection matrix B when it has received the abnormal signal. Then, the fourth calculation unit 30G notifies the fourth calculation unit 30G and the display control unit 34 of the initial arrangement coordinates of the four vertices of the previously temporarily arranged document plane 54, the previous inclination and position matrix, and the previous projection matrix B.

On the other hand, when the restricting unit 30F has not determined an abnormality, the fourth calculation unit 30G notifies the fourth calculation unit 30G and the display control unit 34 of the initial arrangement coordinates of the four vertices of the temporarily arranged document plane 54, the latest inclination and position matrix (virtual region), and the latest projection matrix B.

The fourth calculation unit 30G applies the three-dimensional coordinates (initial arrangement coordinates) of the four vertices of the document plane 54 temporarily arranged in the virtual three-dimensional space to the inclination and position matrix so as to calculate the three-dimensional coordinates of the four vertices of the virtual region corresponding to the specified display region 50 in the virtual three-dimensional space. With this, the fourth calculation unit 30G calculates the virtual region corresponding to the specified display region 50 in the virtual three-dimensional space. Then, the fourth calculation unit 30G notifies the display control unit 34 of the calculated three-dimensional coordinates of the virtual region.

The movement unit 30H, the enlargement/reduction unit 30I, and the rotating unit 30J will be described in detail later.

Referring back to FIG. 2, the display control unit 34 arranges the document image 50 in the calculated virtual region in the virtual three-dimensional space so as to provide a three-dimensional document image. That is to say, the display control unit 34 arranges the document image 50 in the virtual region indicated by the three-dimensional coordinates in the virtual three-dimensional space so as to provide the three-dimensional document image. To be more specific, the display control unit 34 arranges the display region 50 such that each of the four vertices of the display region 50 is identical to each of the four vertices of the virtual region indicated by the three-dimensional coordinates in the virtual three-dimensional space so as to provide the three-dimensional document image.

The display control unit 34 performs control to display, on the display unit 20, a superimposition image formed by superimposing, on the background image, a two-dimensional document image obtained by projecting the above-mentioned three-dimensional document image onto the two-dimensional space visually recognized from a predetermined viewpoint position as the preview image estimating a print result of the document image 50.

The viewpoint position is a position in the −Z-axis direction along the normal line to the document plane 54 temporarily arranged at the above-mentioned reference position in the virtual three-dimensional space. The viewpoint position can be changed to an arbitrary position specified by the user by processing of OpenGL.

That is to say, the display control unit 34 receives, on OpenGL, the document image, the background image, the three-dimensional coordinates (initial arrangement coordinates) of the four vertices of the document plane 54 temporarily arranged in the three-dimensional space, the latest inclination and position matrix as the MODEL-VIEW matrix in OpenGL, the projection matrix B as the PROJECTION matrix, and the light source information and the document reflection information received by the second reception unit 36.

Then, the display control unit 34, using OpenGL, arranges a virtual light source in accordance with the received light source information and document reflection information in the virtual three-dimensional space and arranges the document image in the virtual region corresponding to the specified display region in the virtual three-dimensional space so as to provide a three-dimensional document image added with a light source effect based on the light source information.

Then, the display control unit 34 performs control to display, on the display unit 20, the superimposition image formed by superimposing, on the background image, the two-dimensional document image obtained by projecting the above-mentioned three-dimensional document image onto the two-dimensional space visually recognized from the predetermined viewpoint position as the preview image estimating the print result of the document image 50.

The display control unit 34 uses the projection matrix B calculated by the third calculation unit 30D when the three-dimensional document image is projected onto the two-dimensional space.

The background image may be drawn by OpenGL, or may be superimposed by forming a layer for background image display, placing a display layer for openGL thereon, and transmitting portions other than a portion corresponding to the document image.

When the preview image is displayed on the display unit 20, the user operates the input unit 18 so as to move the position of the two-dimensional document image contained in the preview image to an arbitrary position on the screen of the display unit 20.

For example, the user operates the screen of the UI unit 22 configured as the touch panel so as to touch the two-dimensional document image that is being displayed or the periphery thereof and drag it to a position of an arbitrary movement destination. During the drag, the first reception unit 26 receives the device coordinates of the newly specified display region 50 every time the two-dimensional coordinates are specified newly, and the specifying unit 28 stores the device coordinates of the respective vertices of the specified display region that have been received by the first reception unit 26 as display region information in the storage unit 16.

The arrangement unit 30 performs the above-mentioned processing every time the specifying unit 28 specifies the device coordinates newly, and the display control unit 34 performs control to display the preview image on the display unit 20 in the same manner as described above. Thus, the image processing unit 14 repeatedly executes the above-mentioned display processing of the preview image every time the device coordinates of the display region 50 are specified newly during the drag.

When the user has finished specification of the two-dimensional coordinates of the display region 50, the arrangement unit 30 may finish the processing or the correction unit 30E may perform the correction processing of the projection matrix.

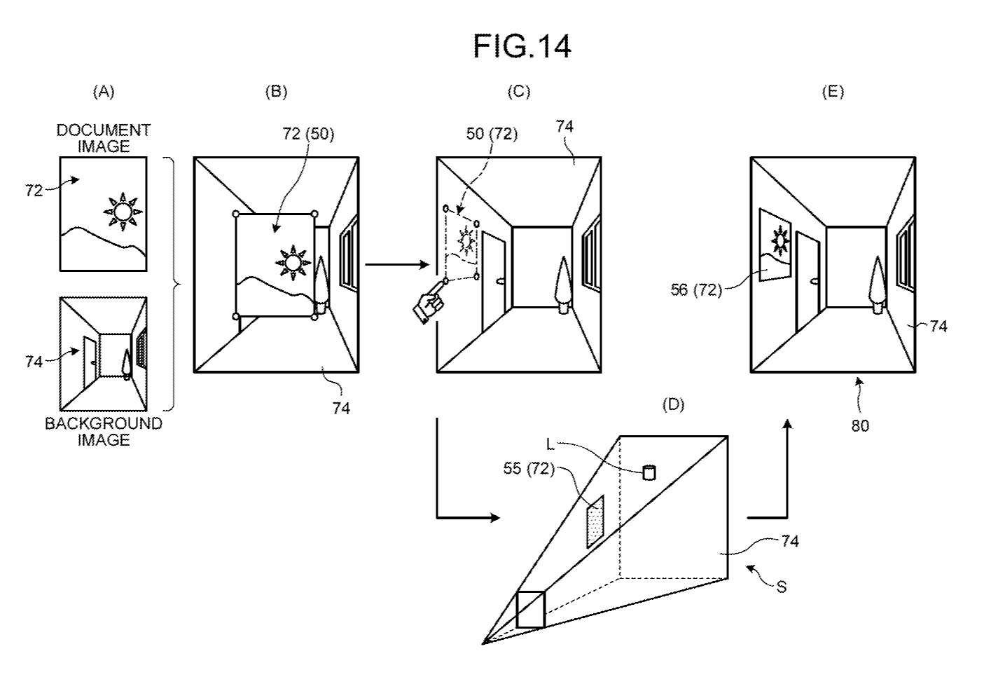

FIG. 14 is a plan view schematically illustrating flow of a series of the preview processing by the image processing unit 14.

First, the first acquisition unit 24 acquires a background image 74 and a document image 72 (see (A) in FIG. 14). The first reception unit 26 receives specification of the display region 50 of the document image 72 (see (B) in FIG. 14). As described above, in the embodiment, the first reception unit 26 receives the device coordinates of the four vertices of the display region 50 from the input unit 18 so as to receive specification of the display region 50 (see (B) in FIG. 14). The user specifies these four vertices using the UI unit 22 configured as the touch panel. Furthermore, the user drags one vertex of the four vertices of the display region 50 to a position desired by the user on the background image 74 by operating the input unit 18 so as to move the respective vertices to positions desired by the user (see (C) in FIG. 14).

Thereafter, the arrangement unit 30 calculates the virtual region 54 corresponding to the specified display region 50 in a virtual three-dimensional space S. The display control unit 34 arranges the document image 72 in the virtual region 54 so as to provide a three-dimensional document image 55 (see (D) in FIG. 14). In this case, the display control unit 34 arranges a virtual light source L indicating the received light source information in the virtual three-dimensional space S so as to provide the three-dimensional document image 55 added with a light source effect in accordance with the received light source information.

To be specific, as described above, the arrangement unit 30 calculates the projection matrix F for projecting the document plane temporarily arranged in the virtual three-dimensional space S onto the two-dimensional space. The arrangement unit 30 further calculates the inclination and position matrix for calculating the inclination and the position of the document image arranged in the virtual region corresponding to the specified display region in the virtual three-dimensional space S using the two-dimensional coordinates of the specified display region 50, the three-dimensional coordinates of the document plane temporarily arranged in the virtual three-dimensional space S, and the projection matrix. Moreover, the arrangement unit 30 calculates the three-dimensional coordinates of the virtual region (position of the three-dimensional document image 55 in FIG. 14) corresponding to the specified display region in the virtual three-dimensional space S by applying the three-dimensional coordinates of the four vertices of the document plane temporarily arranged in the virtual three-dimensional space S to the inclination and position matrix. Furthermore, the arrangement unit 30 changes the position and the posture of the three-dimensional document image 55 in the virtual three-dimensional space S in accordance with input by the user.

The display control unit 34 calls respective functional parts in accordance with input by the user. The display control unit 34 controls an image that is displayed on the display unit 20. The display control unit 34 arranges the document image 72 in the virtual region corresponding to the specified display region 50 in the virtual three-dimensional space S so as to provide the three-dimensional document image 55, using a 3D graphic engine (for example, OpenGL). Then, the display control unit 34 displays, on the display unit 20, a superimposition image 80 formed by superimposing, on the background image 74, a two-dimensional document image 56 obtained by projecting the three-dimensional document image 55 onto the two-dimensional space as a preview image estimating a print result of the document image 72.

Referring back to FIG. 8, then, the display control unit 34 calls the movement unit 30H, the enlargement/reduction unit 30I, and the rotating unit 30J of the arrangement unit 30.

The movement unit 30H, the enlargement/reduction unit 30I, and the rotating unit 30J moves, enlarges or reduces, and rotates the document plane 54 finally arranged at a position corresponding to the specified display region 50 in the virtual three-dimensional space, respectively.

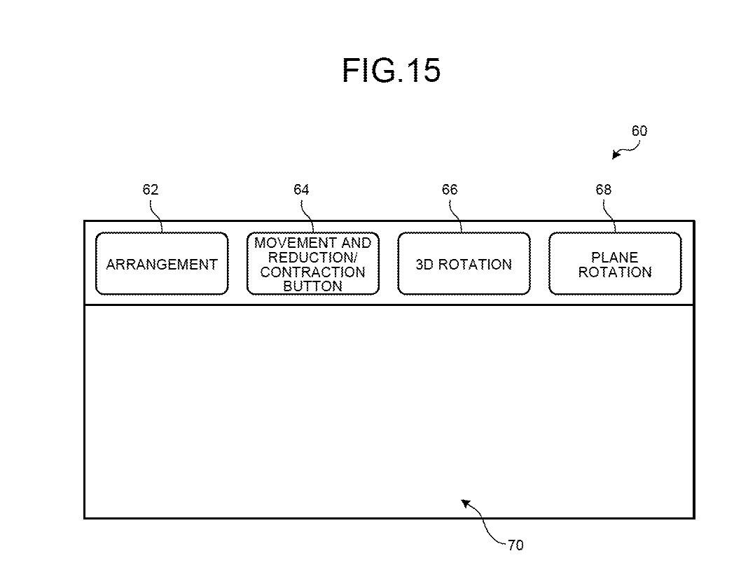

FIG. 15 is a view illustrating an example of a display screen 60.

The display screen 60 includes a display region 70 of the preview image, an arrangement button 62, a movement and enlargement/reduction button 64, a 3D rotation button 66, and a plane rotation button 68.

The preview image is displayed in the display region 70. The arrangement button 62 is an instruction region that the user operates while specifying the display region 50. The movement and enlargement/reduction button 64, the 3D rotation button 66, or the plane rotation button 68 are specified by the user when the user moves, enlarges or reduces, or rotates the two-dimensional document image 56 in the virtual three-dimensional space S. To be specific, the movement and enlargement/reduction button 64 is an instruction region that the user operates when the user instructs movement, enlargement or reduction of the two-dimensional document image 56 contained in the preview image. The 3D rotation button 66 is an instruction region that the user operates when the user rotates the two-dimensional document image 56 contained in the preview image three-dimensionally. The plane rotation button 68 is an instruction region that the user operates when the user rotates the two-dimensional document image 56 contained in the preview image two-dimensionally.

The arrangement button 62, the movement and enlargement/reduction button 64, the 3D rotation button 66, and the plane rotation button 68 can be selected exclusively. When one button is selected, selection of another button is cancelled. At the time of activation of an application, a state where the arrangement button 62 has been selected and the display region 50 can be specified and changed is established.

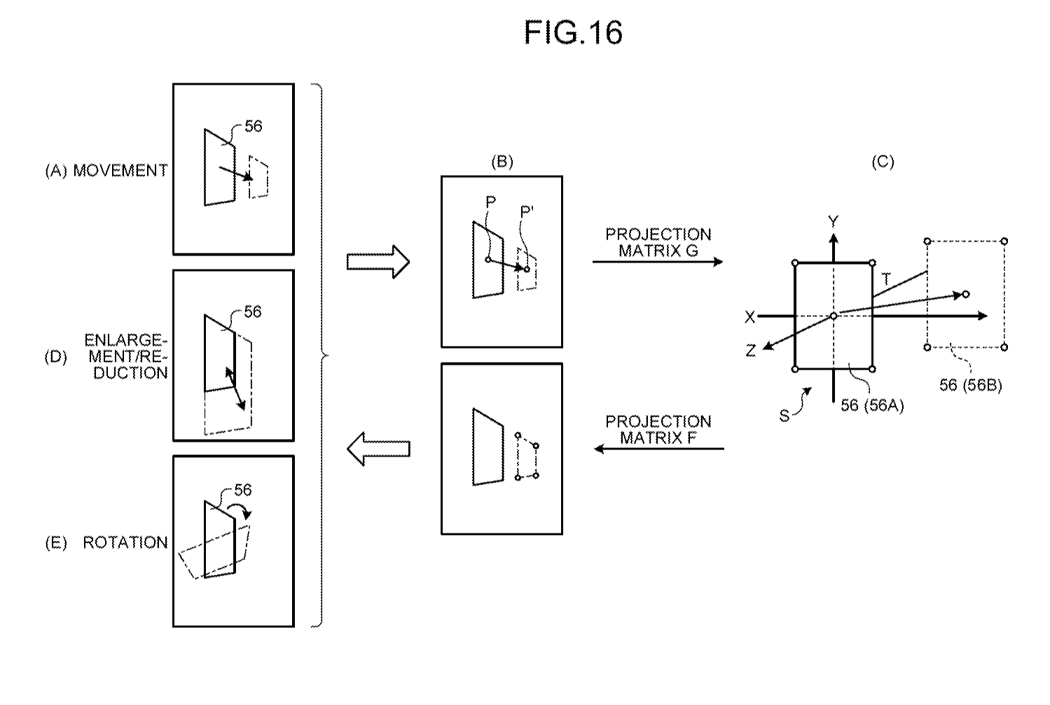

FIG. 16 is an explanatory diagram for explaining movement, enlargement and reduction, and rotation.

It is assumed that the user selects the movement and enlargement/reduction button 64, the 3D rotation button 66, or the plane rotation button 68. The user can also select the arrangement button 62 after the selection.

First, the movement and enlargement/reduction button 64 is described. Processing of moving, enlarging, or reducing the two-dimensional document image 56 contained in the preview image is the most commonly used function. For this reason, a button for instructing these plurality of pieces of processing is set to one movement and enlargement/reduction button 64 in the embodiment. When the UI unit 22 is configured by the touch panel, a movement instruction is made by dragging and an enlargement or reduction instruction is made by pinching-out or pinching-in. That is, the number of fingers of the user that touch the screen of the display unit 20 is different between the movement instruction and the enlargement or reduction instruction. With this difference, processing that the user is about to use can be distinguished even when the same button is used. To be specific, when the user instructs to drag in a state where the movement and enlargement/reduction button 64 is selected, the image processing unit 14 only needs to determine the “movement instruction”. On the other hand, when the user instructs to pinch out or pinch in in a state where the movement and enlargement/reduction button 64 is selected, the image processing unit 14 only needs to determine the “enlargement instruction” or the “reduction instruction”.

The display control unit 34 outputs instruction information (any of the arrangement button 62, the movement and enlargement/reduction button 64, the 3D rotation button 66, and the plane rotation button 68) indicating the selected button and the device coordinates specified by the user to the arrangement unit 30.

The arrangement unit 30 calls the movement unit 30H, the enlargement/reduction unit 30I, or the rotating unit 30J in accordance with the instruction information and the device coordinates that have been received from the display control unit 34.

The movement unit 30H receives the instruction information indicating the movement and enlargement/reduction button 64 and starts to operate when the user performs a drag operation of the two-dimensional document image 56 (see (A) in FIG. 16). The movement unit 30H receives the instruction information (movement instruction) and the drag operation through the first reception unit 26 from the input unit 18.

The movement unit 30H stores therein the device coordinates at the start time of the drag. The movement unit 30H acquires the device coordinates of the respective vertices of the specified display region 50 from the specifying unit 28 and calculates the center of gravity P of the four vertices. In other words, the movement unit 30H obtains the device coordinates and the center of gravity P of the respective vertices of the two-dimensional document image 56 contained in the preview image that is being displayed (see (B) in FIG. 16).

The movement unit 30H may obtain any one vertex of the four vertices or one arbitrary point instead of the center of gravity P. To be specific, the one point needs to be one arbitrary point capable of deriving the object coordinates of the respective four vertices of the two-dimensional document image 56 therefrom. The center of gravity P that is easily controlled is used for description herein.

The movement unit 30H holds the object coordinates of the center of gravity P of the two-dimensional document image 56 at the start time of the drag.

The movement unit 30H subtracts the two-dimensional coordinates at the start time of the drag from the current coordinates (two-dimensional coordinates that are specified currently) so as to calculate a movement vector on the screen of the display unit 20 during a drag operation by the user. Then, the movement unit 30H adds the calculated movement vector to the center of gravity P at the start time of the drag so as to calculate the device coordinates of a current center of gravity P′ (see (B) in FIG. 16).

Thereafter, the movement unit 30H applies the projection matrix G that is held by the arrangement unit 30 to the position of the calculated current center of gravity P′ so as to calculate the position of the two-dimensional document image 56 in the virtual three-dimensional space S. In the calculation, a Z coordinate value is assumed to be 0. With this, the two-dimensional document image 56 is moved to a position of a two-dimensional document image 56B from a position of a two-dimensional document image 56A along the XY plane in the virtual three-dimensional space S (see (C) in FIG. 16).

When the display control unit 34 performs control to display the preview image, the two-dimensional document image 56 moves over the XY plane. A matrix indicating movement to the position of the two-dimensional document image 56B from the position of the two-dimensional document image 56A is assumed to be T. The movement unit 30H only needs to deliver a matrix (RT×T) obtained by multiplying the inclination and position matrix calculated by the second calculation unit 30C by the matrix T as a new inclination and position matrix to the fourth calculation unit 30G and the display control unit 34. It should be noted that RT indicates an inclination and position matrix.

The arrangement unit 30 only needs to calculate the device coordinates using the matrix T and delivers them as the new display region 50 (display region 50 after being changed) to the specifying unit 28.

Thus, the user can move the two-dimensional document image 56 contained in the preview image easily so as to check change of a reflection position by the virtual light source L arranged in the virtual three-dimensional space S easily.

When the enlargement/reduction unit 30I receives the instruction information indicating the movement and enlargement/reduction button 64 and the user operates to pinch out or pinch in the two-dimensional document image 56 (see (D) in FIG. 16), the enlargement/reduction unit 30I starts to operate. The enlargement/reduction unit 30I receives the instruction information (enlargement or reduction instruction) and the pinch-out or pinch-in operation through the first reception unit 26 from the input unit 18.

Then, the enlargement/reduction unit 30I calculates a distance between the two vertices at the start time of the pinch-out or pinch-in and records it. The enlargement/reduction unit 30I also calculates the distance between the two vertices during the pinch-out or pinch-in. A value calculated by dividing the distance between the two vertices during the pinch-out or pinch-in by the distance between the two vertices at the start time of the pinch-out or pinch-in is handled as a specified magnification. The object initial coordinates are on the XY plane and the magnification is applied to only XY coordinates. The enlargement/reduction unit 30I stores a matrix when the two-dimensional document image 56 is pinched out or pinched in as a matrix S.

The enlargement/reduction unit 30I only needs to deliver a matrix (RT×S) obtained by multiplying the inclination and position matrix calculated by the second calculation unit 30C by the matrix S as a new inclination and position matrix to the fourth calculation unit 30G and the display control unit 34. When enlargement or reduction is instructed after the movement by the movement unit 30H, the enlargement/reduction unit 30I only needs to deliver a matrix (RT×T×S) obtained by multiplying the inclination and position matrix calculated by the second calculation unit 30C by the matrix T and the matrix S as a new inclination and position matrix to the fourth calculation unit 30G and the display control unit 34. With this, the preview image containing the enlarged two-dimensional document image 56 is displayed.

The arrangement unit 30 only needs to calculate the device coordinates and delivers them as the new display region 50 (display region 50 after being changed) to the specifying unit 28 in the same manner as the case of the movement unit 30H. The arrangement unit 30 delivers a magnification of the enlargement or reduction to the display control unit 34. The display control unit 34 performs control to display the received magnification on the display unit 20 together with the preview image. With the display of the magnification on the display unit 20, when an image of an object or the like indicating the size as a reference is contained in the background image, the user can easily estimate the magnification of the two-dimensional document image 56 that should be applied. To be specific, the user can consider whether the document image is output as a poster of an A3 size or output as a poster of an A1 size and so on based on the displayed magnification while checking the preview image.

When the rotating unit 30J receives the instruction information indicating the 3D rotation button 66 or the plane rotation button 68 (see (E) in FIG. 16), the rotating unit 30J starts to operate. The rotating unit 30J receives the instruction information (two-dimensional rotation instruction or three-dimensional rotation instruction) through the first reception unit 26 from the input unit 18.

When the rotating unit 30J receives the instruction information (three-dimensional rotation instruction) indicating the 3D rotation button 66, it rotates the two-dimensional document image 56 three-dimensionally in accordance with a drag by an instruction or the like using the input unit 18 by the user. To be specific, the rotating unit 30J generates a three-dimensional rotation matrix in accordance with the drag using the input unit 18 such as a mouse.

In the embodiment, a known trackball control technique is used for generation of the three-dimensional rotation matrix. It is assumed that the three-dimensional rotation matrix is R₃. In this case, the rotating unit 30J delivers a matrix expressed by the following equation (18) as a new inclination and position matrix to the fourth calculation unit 30G and the display control unit 34. With the transfer, the preview image containing the two-dimensional document image 56 rotated three-dimensionally is displayed on the display unit 20.

RT×R₃ (18)

When the three-dimensional rotation is instructed after the movement by the movement unit 30H and the enlargement or reduction by the enlargement/reduction unit 30I, the rotating unit 30J delivers a matrix expressed by the following equation (19) as a new inclination and position matrix to the fourth calculation unit 30G and the display control unit 34. With the transfer, the preview image containing the two-dimensional document image 56 rotated three-dimensionally is displayed on the display unit 20.

RT×T×R₃×S (19)

The arrangement unit 30 calculates the device coordinates and delivers them as the new display region 50 (display region 50 after being changed) to the specifying unit 28 in the same manner as the case of the movement unit 30H. The preview image containing the two-dimensional document image 56 rotated three-dimensionally is displayed on the display unit 20. This display enables the user to check a light source reflection effect easily.

When the rotating unit 30J receives the instruction information (two-dimensional rotation instruction) indicating the plane rotation button 68 (see (E) in FIG. 16), it rotates the two-dimensional document image 56 in the virtual three-dimensional space S along the XY plane two-dimensionally in accordance with a drag by an instruction or the like using the input unit 18 by the user. To be specific, the rotating unit 30J generates a two-dimensional rotation matrix in accordance with the drag using the input unit 18 such as a mouse.

In this case, the rotating unit 30J handles a movement amount from a drag start point as a radian multiplied by a predetermined coefficient. The rotating unit 30J generates a two-dimensional rotation matrix R₂ using the radian. The rotating unit 30J delivers a matrix expressed by the following equation (20) as a new inclination and position matrix to the fourth calculation unit 30G and the display control unit 34. With the transfer, the preview image containing the two-dimensional document image 56 rotated two-dimensionally is displayed on the display unit 20.

RT×R₂ (20)

When the two-dimensional rotation is further instructed after the movement by the movement unit 30H, the enlargement or reduction by the enlargement/reduction unit 30I, and the three-dimensional rotation, then the rotating unit 30J delivers a matrix expressed by the following equation (21) as a new inclination and position matrix to the fourth calculation unit 30G and the display control unit 34. With the transfer, the preview image containing the two-dimensional document image 56 rotated two-dimensionally is displayed on the display unit 20.

RT×T×R₃×R₂×S (21)

The arrangement unit 30 only needs to calculate the device coordinates and delivers them as the new display region 50 (display region 50 after being changed) to the specifying unit 28 in the same manner as the case of the movement unit 30H. The arrangement unit 30 arranges the two-dimensional document image 56 on the XY plane parallel with the background image. The background image is not limited to be in a perpendicular or horizontal state all the time and is inclined in some cases, so that the rotation is preferably used. When the document image is arranged on the background image such as a desk, planar rotation is performed in order to make a state where the document image is placed rightly when seen from the sitting user. The two-dimensional rotation is performed more easily than the three-dimensional rotation.

At least two of the movement unit 30H, the enlargement/reduction unit 30I, and the rotating unit 30J may be combined for use. Furthermore, when the user operates to select the arrangement button 62 and specify the display region 50 again, T, R₃, R₂, and S only need to be made unit matrices.

The two-dimensional document image 56 can be moved, enlarged or reduced, and rotated using the movement and enlargement/reduction button 64, the 3D rotation button 66, and the plane rotation button 68. The posture of the two-dimensional document image 56 in the three-dimensional virtual space S can be therefore changed easily in a state where the shape of the display region 50 once settled is maintained without operating and moving all the four vertices of the two-dimensional document image 56.

The user can adjust the position of the two-dimensional document image 56 in the preview image easily.

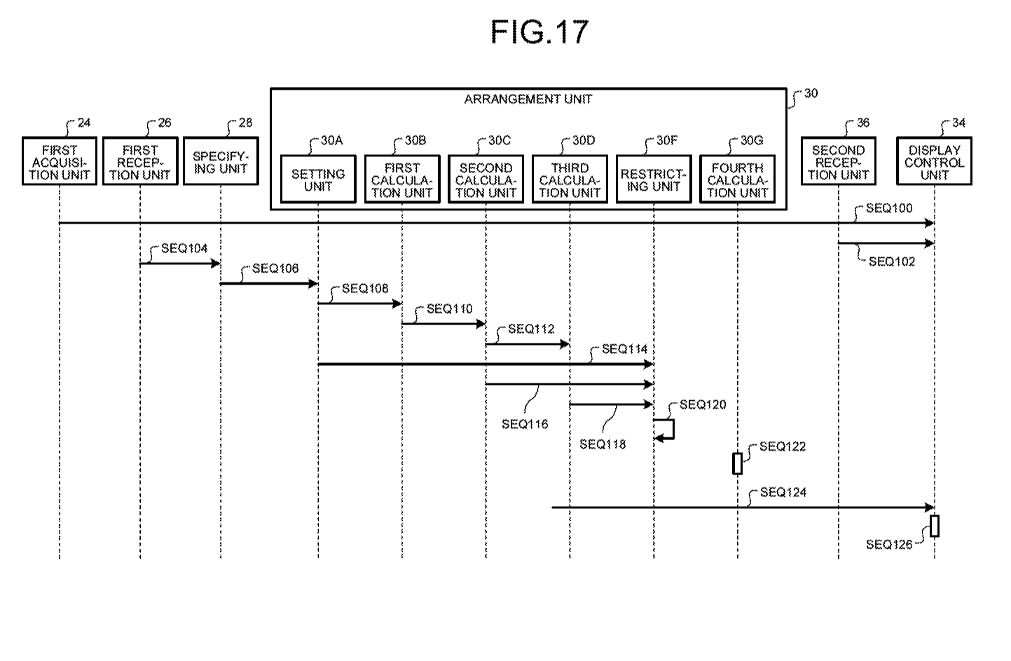

Next, flow of preview processing that is executed by the image processing unit 14 will be described. FIG. 17 is an explanatory diagram for explaining the flow of the preview processing that is executed by the image processing unit 14.

First, the first acquisition unit 24 acquires the document image and the background image and outputs them to the display control unit 34 (SEQ100). The second reception unit 36 receives the light source information and the document reflection information and outputs them to the display control unit 34 (SEQ102).

The first reception unit 26 receives specification of the display region of the document image on the screen of the display unit 20 from the user and outputs it to the specifying unit 28 (SEQ104). The specifying unit 28 sets the display region received by the first reception unit 26 as a specified display region and outputs it to the setting unit 30A of the arrangement unit 30 (SEQ106).

The setting unit 30A acquires the display region 50 set by the specifying unit 28. Then, the setting unit 30A temporarily arranges the document image as the preview target on the XY plane with Z=0 in the three-dimensional space so as to provide the document plane 54. The setting unit 30A outputs the initial arrangement coordinates (three-dimensional coordinates) of the temporarily arranged document plane 54 to the first calculation unit 30B (SEQ108).

The first calculation unit 30B calculates the projection matrix F for projecting the initial arrangement coordinates of the document plane 54 temporarily arranged in the virtual three-dimensional space onto device coordinates in the two-dimensional space, and the inverse projection matrix G thereof. Then, the first calculation unit 30B outputs the projection matrix F to the second calculation unit 30C (SEQ110).

The second calculation unit 30C calculates the inclination and position matrix using the projection matrix F acquired from the first calculation unit 30B and the optical characteristic parameters of the photographing unit 12. Then, the second calculation unit 30C outputs the calculated inclination and position matrix, the projection matrix F, and the optical characteristic parameters used for calculation to the third calculation unit 30D (SEQ112).

The third calculation unit 30D calculates the projection matrix B for projecting the three-dimensional image arranged in the virtual three-dimensional space onto the two-dimensional image (that is, projecting the three-dimensional coordinates in the virtual three-dimensional space onto the two-dimensional coordinates in the two-dimensional space).

The restricting unit 30F acquires the initial arrangement coordinates of the four vertices of the temporarily arranged document plane 54 from the setting unit 30A (SEQ114). The restricting unit 30F acquires the latest projection matrix B from the second calculation unit 30C (SEQ116) and acquires the inclination and position matrix from the second calculation unit 30C (SEQ118). The restricting unit 30F calculates the normalized two-dimensional coordinates of the respective four vertices from the initial arrangement coordinates of the four vertices of the temporarily arranged document plane 54, the inclination and position matrix, and the projection matrix B. In this case, when Z coordinates of the normalized two-dimensional coordinates of the all four vertices are equal to or larger than 0, that is, when they are located at the rear side of the virtual camera photographing the virtual three-dimensional space (opposite side to the photographing direction), then the restricting unit 30F determines an abnormality (SEQ120).

The fourth calculation unit 30G determines whether the restricting unit 30F has determined an abnormality (SEQ122). When the restricting unit 30F has determined an abnormality, the fourth calculation unit 30G notifies the specifying unit 28 (see FIG. 2), the second calculation unit 30C, and the third calculation unit 30D of an abnormal signal. On the other hand, when the restricting unit 30F has not determined an abnormality, the fourth calculation unit 30G notifies the fourth calculation unit 30G and the display control unit 34 of the initial arrangement coordinates of the four vertices of the temporarily arranged document plane 54, the latest inclination and position matrix (virtual region), and the latest projection matrix B (SEQ124).

The display control unit 34 arranges the document image 50 in the calculated virtual region in the virtual three-dimensional space so as to obtain a three-dimensional document image. That is to say, the display control unit 34 arranges the document image 50 in the virtual region indicated by the three-dimensional coordinates in the virtual three-dimensional space so as to obtain the three-dimensional document image. The display control unit 34 performs control to display, on the display unit 20, the superimposition image formed by superimposing, on the background image, the two-dimensional document image obtained by projecting the three-dimensional document image onto the two-dimensional space visually recognized from the predetermined viewpoint position as the preview image estimating a print result of the document image 50 (SEQ126).

When the new display region 50 is specified by an operation such as dragging by the user, the process returns to SEQ100 or SEQ104.

As described above, the image processing apparatus 10 in the embodiment includes the first acquisition unit 24, the first reception unit 26, the arrangement unit 30, and the display control unit 34. The first acquisition unit 24 acquires the document image. The first reception unit 26 receives specification of the display region of the document image on the screen of the display unit. The arrangement unit 30 calculates the virtual region corresponding to the specified display region in the virtual three-dimensional space. The display control unit 34 performs control to display, on the display unit 20, the superimposition image formed by superimposing the background image and the two-dimensional document image obtained by projecting the three-dimensional document image formed by arranging the document image in the calculated virtual region onto the two-dimensional space visually recognized from the predetermined viewpoint position as the preview image estimating a print result of the document image.

The user specifies the display region on the two-dimensional screen of the display unit 20 so as to check the preview image formed by arranging the two-dimensional document image based on the document image of the preview target in the virtual region corresponding to the specified display region in the virtual three-dimensional space. That is to say, the image processing apparatus 10 can provide the preview image formed by arranging the document image at a position desired by the user without making the user conscious of the structure of the virtual three-dimensional space.

Accordingly, in the image processing apparatus 10 in the embodiment, an object (document image) can be arranged in the virtual three-dimensional space easily.

That is to say, in the image processing apparatus 10 in the embodiment, the user does not need to be conscious of the posture, the structure, and the like of the document image in the virtual three-dimensional space at all, while the user specifies the display region 50 by dragging or the like or specifies new device coordinates of the display region 50. With the image processing apparatus 10 in the embodiment, specification and drag of the new device coordinates by an operation using the input unit 18 by the user are provided by mouse click, multi touch on a touch panel, or the like. The user therefore does not need to be conscious of the device coordinates (two-dimensional coordinates) on the screen of the display unit 20. The image processing apparatus 10 in the embodiment enables the user to check the preview image on which the document image is arranged at a desired position easily.

The first reception unit 26 receives specification of the two-dimensional coordinates on the screen of the display unit 20 as specification of the display region. The arrangement unit 30 calculates three-dimensional coordinates of the virtual region in the virtual three-dimensional space using the projection matrix for projecting the document plane obtained by temporarily arranging the document image in the virtual three-dimensional space onto the two-dimensional space, the two-dimensional coordinates of the specified display region 50, and the document image. Then, the display control unit 34 performs control to display, on the display unit 20, the superimposition image formed by superimposing, on the background image, the two-dimensional document image obtained by projecting the three-dimensional document image formed by arranging the document image in the virtual region having the calculated three-dimensional coordinates in the virtual three-dimensional space onto the two-dimensional space as the preview image.

In the above-mentioned manner, the image processing apparatus 10 calculates the virtual region corresponding to the specified display region in the virtual three-dimensional space. The user therefore does not need to be conscious of the posture, the structure, and the like of the document image in the virtual three-dimensional space at all, while the user specifies the display region 50 by dragging or the like or specifies new device coordinates of the display region 50. That is to say, the user can check the preview image on which the document image is arranged in the desired display region without being conscious of the positional coordinates, the posture, and the like in the virtual three-dimensional space only by setting the display region in the two-dimensional space like the display surface of the display unit 20.

### Second Embodiment

In the first embodiment, the planar two-dimensional image is used as the document image as the preview target. In the embodiment, a stereoscopic document image as a three-dimensional stereoscopic object is used as the document image as the preview target.

FIG. 1 is a plan view schematically illustrating an image processing apparatus 10A in the embodiment.

The image processing apparatus 10A includes the photographing unit 12, an image processing unit 14A, the storage unit 16, the input unit 18, and the display unit 20. The photographing unit 12, the image processing unit 14A, the storage unit 16, the input unit 18, and the display unit 20 are electrically connected to one another through a bus. The photographing unit 12, the storage unit 16, the input unit 18, and the display unit 20 are the same as those in the first embodiment.

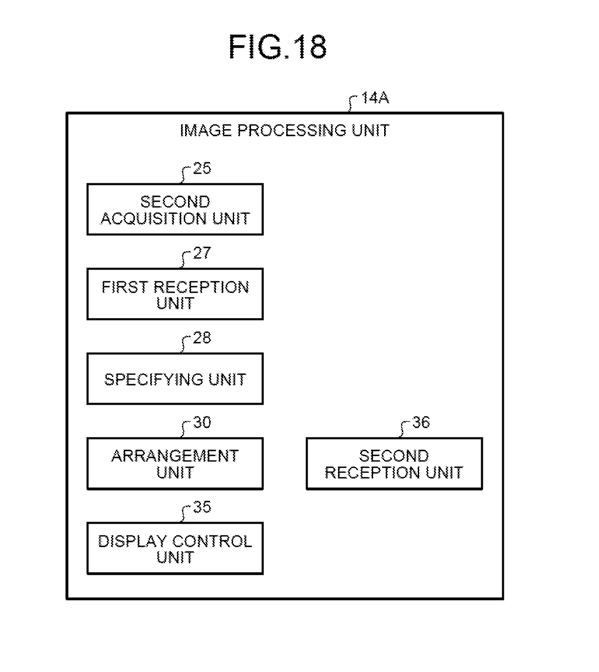

FIG. 18 is a block diagram illustrating the functional configuration of the image processing unit 14A. The image processing unit 14A includes a second acquisition unit 25, a first reception unit 27, the specifying unit 28, the arrangement unit 30, a display control unit 35, and the second reception unit 36.

Some or all of the second acquisition unit 25, the first reception unit 27, the specifying unit 28, the arrangement unit 30, the display control unit 35, and the second reception unit 36 may be made to operate by causing a processing device such as the CPU to execute programs, that is, by software, by hardware such as an IC, or by software and hardware in combination.

The first acquisition unit 24 acquires a stereoscopic document image. The stereoscopic document image is an image of an object as the preview target and is stereoscopic polygon information, for example.

The first reception unit 27 receives specification of a display region of one reference plane of the stereoscopic document image on the screen of the display unit 20 from the user. The reference plane is one of planes configuring the stereoscopic document image. For example, when the stereoscopic document image is a regular hexahedron configured by six planes, the reference plane is one plane of the six planes.

That is to say, in the embodiment, the user specifies the display region of the reference plane on the screen of the display unit 20 using one plane of the stereoscopic document image as the reference plane.

Pieces of processing by the specifying unit 28, the arrangement unit 30, and the second reception unit 36 are the same as those in the first embodiment other than a point that the specified display region is one reference plane of the stereoscopic document image.

The display control unit 35 arranges the stereoscopic document image such that the reference plane of the stereoscopic document image is identical to the virtual region calculated by the arrangement unit 30 in the virtual three-dimensional space so as to provide a three-dimensional document image. To be specific, the display control unit 35 arranges the stereoscopic document image such that each of the four vertices of the reference plane of the stereoscopic document image is identical to each of the four vertices of the virtual region indicated by the three-dimensional coordinates in the virtual three-dimensional space so as to provide the three-dimensional document image.

In the same manner as the display control unit 34 in the first embodiment, the display control unit 35 performs control to display, on the display unit 20, a superimposition image formed by superimposing, on a background image, a two-dimensional document image obtained by projecting the above-mentioned three-dimensional document image onto the two-dimensional space visually recognized from a predetermined viewpoint position as the preview image estimating a print result of the stereoscopic document image.

That is to say, the display control unit 35 receives, on OpenGL, the stereoscopic document image, the background image, the three-dimensional coordinates (initial arrangement coordinates) of the four vertices of the document plane temporarily arranged in the three-dimensional space, the latest inclination and position matrix as the MODEL-VIEW matrix in OpenGL, the projection matrix B as the PROJECTION matrix, and the light source information and the document reflection information received by the second reception unit 36. The document plane temporarily arranged in the virtual three-dimensional space corresponds to a document plane obtained by temporarily arranging the reference plane of the stereoscopic document image in the virtual three-dimensional space in the embodiment.

Then, the display control unit 35, using OpenGL, arranges a virtual light source in accordance with the received light source information and document reflection information in the virtual three-dimensional space and arranges the stereoscopic document image such that the four vertices of the reference plane of the stereoscopic document image are identical to the four vertices of the virtual region corresponding to the specified display region in the virtual three-dimensional space so as to provide a three-dimensional document image added with a light source effect in accordance with the light source information.

Then, the display control unit 35 performs control to display, on the display unit 20, the superimposition image formed by superimposing, on the background image, the two-dimensional document image obtained by projecting the three-dimensional document image onto the two-dimensional space visually recognized from the predetermined viewpoint position as the preview image estimating a print result of the stereoscopic document image.

The display control unit 35 uses the projection matrix B calculated by the third calculation unit 30D when the three-dimensional document image is projected onto the two-dimensional space as in the first embodiment.

Even when CG is used for the background image, the stereoscopic document image can be arranged freely. This is because OpenGL of the 3D graphic engine that is used in the embodiment can set the PROJECTION matrix and the MODEL-VIEW matrix for each drawing object.

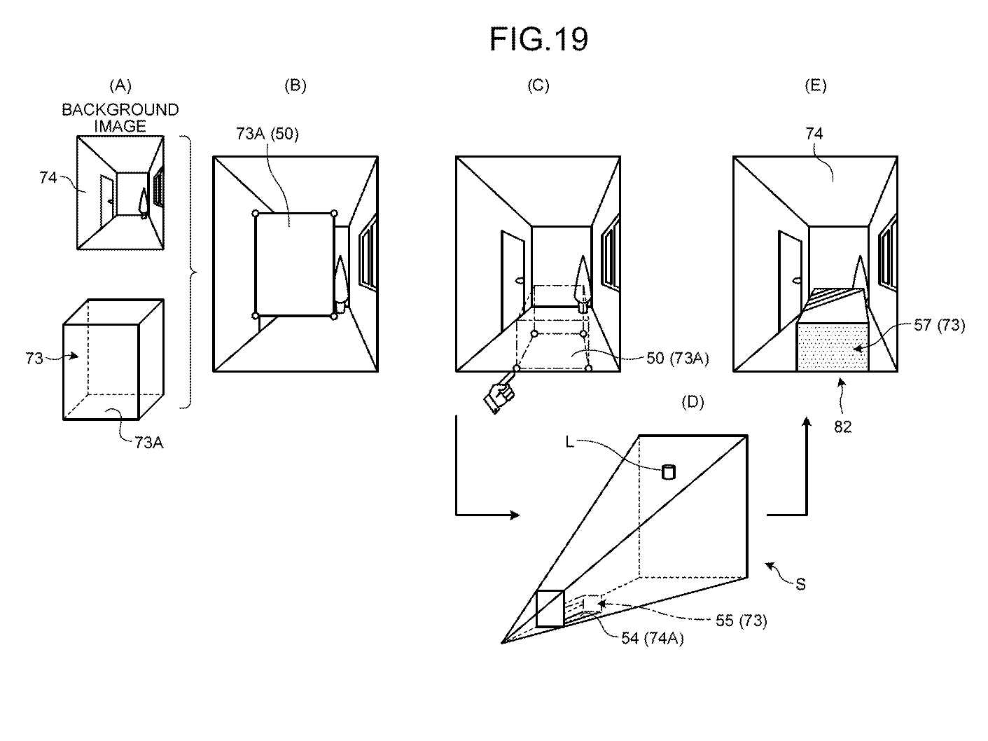

FIG. 19 is a plan view schematically illustrating flow of a series of preview processing by the image processing unit 14A.

First, the second acquisition unit 25 acquires the background image 74 and a stereoscopic document image 73 (see (A) in FIG. 19). Then, the first reception unit 27 receives specification of the display region 50 of a reference plane 73A on the stereoscopic document image 73 (see (B) in FIG. 19). In the embodiment, the first reception unit 27 receives the device coordinates of the four vertices of the display region 50 from the input unit 18 so as to receive specification of the display region 50 of the reference plane 73A (see (B) in FIG. 19). The user specifies these four vertices using the UI unit 22 configured as the touch panel. Furthermore, the user drags one vertex of the four vertices of the display region 50 to a position desired by the user on the background image 74 by operating the input unit 18 so as to move the respective vertices to positions desired by the user (see (C) in FIG. 19).

Thereafter, the arrangement unit 30 calculates the virtual region 54 corresponding to the specified display region 50 in the virtual three-dimensional space S. The display control unit 34 arranges the stereoscopic document image 73 such that the reference plane 73A of the stereoscopic document image 73 is identical to the virtual region 54 so as to provide the three-dimensional document image 55 (see (D) in FIG. 19). In this case, the display control unit 35 arranges a virtual light source L indicating the received light source information in the virtual three-dimensional space S so as to provide the three-dimensional document image 55 added with a light source effect in accordance with the received light source information.

The display control unit 35 performs control to display, on the display unit 20, a superimposition image 82 formed by superimposing, on the background image 74, a two-dimensional document image 57 obtained by projecting the three-dimensional document image 55 onto the two-dimensional space as the preview image estimating a print result of the stereoscopic document image 73 using the 3D graphic engine (for example, OpenGL) (see (E) in FIG. 19).

As described above, the image processing apparatus 10A in the embodiment includes the second acquisition unit 25, the first reception unit 27, the arrangement unit 30, and the display control unit 35. The second acquisition unit 25 acquires the stereoscopic document image. The first reception unit 27 receives specification of the display region of one reference plane of the stereoscopic document image on the screen of the display unit 20. The arrangement unit 30 calculates a virtual region corresponding to the specified display region in the virtual three-dimensional space. The display control unit 35 performs control to display, on the display unit 20, the superimposition image formed by superimposing the background image and the two-dimensional document image obtained by projecting the three-dimensional document image formed by arranging the stereoscopic document image such that the reference plane of the stereoscopic document image is identical to the calculated virtual region onto the two-dimensional space visually recognized from the predetermined viewpoint position as the preview image estimating a print result of the stereoscopic document image.

The image processing apparatus 10A in the embodiment can provide the same effects as those provided in the first embodiment also in the case where the stereoscopic document image is used as the preview target.

### Third Embodiment

Next, the hardware configuration of the image processing apparatuses 10 and 10A as described above will be described.

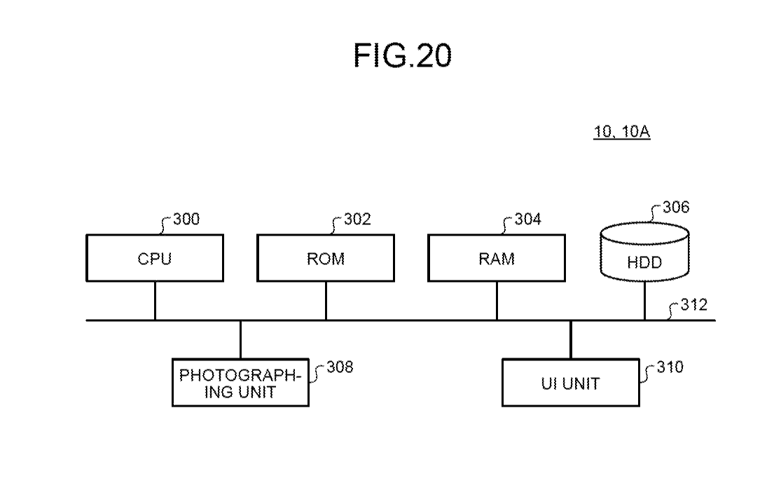

FIG. 20 is a diagram illustrating the hardware configuration of the image processing apparatuses 10 and 10A. The image processing apparatus 10 or 10A includes a central processing unit (CPU) 300 controlling the entire apparatus, a read only memory (ROM) 302 storing therein various pieces of data and various programs, a random access memory (RAM) 304 storing therein various pieces of data and various programs, a hard disc drive (HDD) 306 storing therein various pieces of data, a photographing unit 308, and a user interface (UI) unit 310 such as a touch panel having an input function and an output function mainly as the hardware configuration. The hardware configuration of the image processing apparatuses 10 and 10A is the hardware configuration using a normal computer. It should be noted that the photographing unit 308 corresponds to the photographing unit 12 in FIG. 1 and the UI unit 310 corresponds to the UI unit 22 in FIG. 1. The HDD 306 corresponds to the storage unit 16 in FIG. 1.

Programs that are executed by the image processing apparatus 10 or 10A in the above-mentioned embodiment are recorded and provided as computer program products in a computer-readable recording medium such as a compact disc read only memory (CD-ROM), a flexible disk (FD), a compact disc recordable (CD-R), and a digital versatile disc (DVD), as an installable or executable file.

Furthermore, the programs that are executed by the image processing apparatus 10 or 10A in the above-mentioned embodiment may be stored in a computer connected to a network such as the Internet and provided by being downloaded via the network. The programs that are executed by the image processing apparatus 10 or 10A in the above-mentioned embodiment may be provided or distributed via a network such as the Internet.

The programs that are executed by the image processing apparatus 10 or 10A in the above-mentioned embodiment may be embedded and provided in the ROM 302, for example.

The programs that are executed by the image processing apparatus 10 or 10A in the above-mentioned embodiment have a module configuration including the above-mentioned respective parts. As actual hardware, for example, the CPU 300 reads and executes the programs from the above-mentioned storage medium, so that the above-mentioned respective parts are loaded on a main storage device to be generated on the main storage device.

An embodiment provides an effect that a document image can be easily arranged in a virtual three-dimensional space.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a first acquisition unit that acquires a document image;
a first reception unit that receives specification of a display region of the document image on a screen of a display unit;
an arrangement unit that calculates a virtual region corresponding to the specified display region in a virtual three-dimensional space; and
a display control unit that performs control to display, on the display unit, a superimposition image formed by superimposing a background image and a two-dimensional document image obtained by projecting a three-dimensional document image formed by arranging the document image in the calculated virtual region onto a two-dimensional space visually recognized from a predetermined viewpoint position as a preview image estimating a print result of the document image.

2. The image processing apparatus according to claim 1, wherein
the first reception unit receives specification of two-dimensional coordinates on the screen of the display unit as the specification of the display region,
the arrangement unit calculates three-dimensional coordinates of the virtual region in the virtual three-dimensional space using a projection matrix for projecting a document plane obtained by temporarily arranging the document image at a predetermined reference position in the virtual three-dimensional space onto the two-dimensional space on the screen, the two-dimensional coordinates of the specified display region, and the document image, and
the display control unit performs control to display, on the display unit, the superimposition image formed by superimposing the two-dimensional document image obtained by projecting the three-dimensional document image formed by arranging the document image in the virtual region having the calculated three-dimensional coordinates in the virtual three-dimensional space onto the two-dimensional space visually recognized from the viewpoint position and the background image as the preview image.

3. The image processing apparatus according to claim 2, wherein the arrangement unit comprises:
a first calculation unit that calculates the projection matrix;
a second calculation unit that calculates an inclination and position matrix for calculating an inclination and a position of the document image arranged in the virtual region using the two-dimensional coordinates of the display region, the three-dimensional coordinates of the document plane, and the projection matrix, and
a fourth calculation unit that calculates the three-dimensional coordinates of the virtual region in the virtual three-dimensional space by applying three-dimensional coordinates of four vertices of the document plane having a rectangular shape temporarily arranged in the virtual three-dimensional space to the inclination and position matrix.

4. The image processing apparatus according to claim 3, wherein the second calculation unit calculates the inclination and position matrix using the two-dimensional coordinates of the display region, the three-dimensional coordinates of the document plane, the projection matrix, and an optical characteristic parameter of a photographing unit photographing the background image.

5. The image processing apparatus according to claim 1, further comprising a second reception unit that receives light source information indicating reflection characteristics of a virtual light source arranged in the virtual three-dimensional space, wherein
the display control unit performs control to display, on the display unit, the superimposition image formed by superimposing the background image and the two-dimensional document image while arranging the virtual light source indicating the light source information in the virtual three-dimensional space, as the preview image.

6. The image processing apparatus according to claim 1, wherein the first reception unit receives specification of a rectangular region on the screen of the display unit as the specification of the display region.

7. The image processing apparatus according to claim 1, wherein the first reception unit receives specification of four vertices of a rectangular region on the screen of the display unit as the specification of the display region.

8. The image processing apparatus according to claim 1, wherein the first reception unit receives selection and movement of one vertex out of four vertices of a rectangular region on the screen of the display unit and receives a rectangular region containing, as vertices, the one vertex after being moved and the other three vertices as the specification of the display region.

9. The image processing apparatus according to claim 2, wherein the arrangement unit includes a restricting unit that performs control to use the display region specified previously when a position of the virtual region in the virtual three-dimensional space is located in a direction toward the viewpoint position from the reference position in the virtual three-dimensional space.

10. The image processing apparatus according to claim 3, wherein
the first reception unit receives a movement instruction of the two-dimensional document image on the preview image displayed on the display unit, and
the arrangement unit includes a movement unit that outputs, to the fourth calculation unit, a matrix obtained by multiplying a matrix indicating movement of the two-dimensional document image to a position specified by the received movement instruction by the inclination and position matrix calculated by the second calculation unit as a new inclination and position matrix.

11. The image processing apparatus according to claim 3, wherein
the first reception unit receives an enlargement or reduction instruction indicating enlargement or reduction of the two-dimensional document image on the preview image displayed on the display unit, and
the arrangement unit includes an enlargement or reduction unit that outputs, to the fourth calculation unit, a matrix obtained by multiplying a matrix indicating an enlargement magnification or a reduction magnification specified by the received enlargement or reduction instruction by the inclination and position matrix calculated by the second calculation unit as a new inclination and position matrix.

12. The image processing apparatus according to claim 3, wherein
the first reception unit receives a three-dimensional rotation instruction indicating three-dimensional rotation of the two-dimensional document image on the preview image displayed on the display unit, and
the arrangement unit includes a rotating unit that outputs, to the fourth calculation unit, a matrix obtained by multiplying a matrix indicating rotation indicated by the received three-dimensional rotation instruction by the inclination and position matrix calculated by the second calculation unit as a new inclination and position matrix.

13. The image processing apparatus according to claim 3, wherein
the first reception unit receives a two-dimensional rotation instruction indicating two-dimensional rotation of the two-dimensional document image on the preview image displayed on the display unit, and
the arrangement unit includes a rotating unit that outputs, to the fourth calculation unit, a matrix obtained by multiplying a matrix indicating rotation indicated by the received two-dimensional rotation instruction by the inclination and position matrix calculated by the second calculation unit as a new inclination and position matrix.

14. An image processing apparatus comprising:
a second acquisition unit that acquires a stereoscopic document image;
a first reception unit that receives specification of a display region of one reference plane of the stereoscopic document image on a screen of a display unit;
an arrangement unit that calculates a virtual region corresponding to the specified display region in a virtual three-dimensional space; and
a display control unit that performs control to display, on the display unit, a superimposition image formed by superimposing a background image and a two-dimensional document image obtained by projecting a three-dimensional document image formed by arranging the stereoscopic document image such that the reference plane of the stereoscopic document image is identical to the calculated virtual region, onto a two-dimensional space visually recognized from a predetermined viewpoint position as a preview image estimating a print result of the stereoscopic document image.

15. An image processing method comprising:
acquiring a document image;
receiving specification of a display region of the document image on a screen of a display unit;
calculating a virtual region corresponding to the specified display region in a virtual three-dimensional space; and
performing control to display, on the display unit, a superimposition image formed by superimposing a background image and a two-dimensional document image obtained by projecting a three-dimensional document image formed by arranging the document image in the calculated virtual region onto a two-dimensional space visually recognized from a predetermined viewpoint position as a preview image estimating a print result of the document image.
